(19) United States
(12) Patent Application Publication
(10) Pub. No.: US 2024/0423205 A1
(43) Pub. Date: Dec. 26, 2024

(54) TURF GRASS TREATMENT COMPOSITIONS AND METHODS OF USE

(71) Applicant: AQUATROLS CORPORATION OF AMERICA, Paulsboro, NJ (US)

(72) Inventors: Casey Edward McDONALD, Delaware, OH (US); Arianna Lubomyra WATTERS, Philadelphia, PA (US); Emma Catherine BEGGS, Merseyside (GB); Darryl RAMOUTAR, Delaware, OH (US)

(73) Assignee: AQUATROLS CORPORATION OF AMERICA, Paulsboro, NJ (US)

(21) Appl. No.: 18/750,519

(22) Filed: Jun. 21, 2024

Related U.S. Application Data
(60) Provisional application No. 63/522,889, filed on Jun. 23, 2023.

(51) Int. Cl. A01N 43/16; A01N 25/30; A01N 63/20; A01N 63/30; A01N 63/32; A01P 21/00

(52) U.S. Cl. CPC A01N 43/16; A01N 25/30; A01N 63/20; A01N 63/30; A01N 63/32; A01P 21/00

(57) ABSTRACT

This disclosure provides a turf grass treatment composition having at least one biosurfactant. The turf grass treatment composition, when applied to turf grass, or to roots of the turf grass, or to soil in which the turf grass grows, is effective for enhancing quality of the turf grass. The turf grass treatment composition optionally has at least one naturally-derived surfactant, at least one plant health component or biostimulant, and at least one inert component. The turf grass treatment composition enhances quality of the turf grass, for example, by enhancing root structure and growth, nutrient use efficiency, water use efficiency, stress tolerance, disease tolerance, and/or inducing systemic resistance. This disclosure also provides a method of enhancing quality of turf grass by applying to the turf grass, or to roots of the turf grass, or to soil in which the turf grass grows, the turf grass treatment composition.

### RELATED APPLICATION

This application claims the benefit of copending U.S. Application No. 63/522,889, filed Jun. 23, 2023, which is incorporated herein by reference in its entirety.

### BACKGROUND OF THE DISCLOSURE

### 1. Field of the Disclosure

This disclosure relates to turf grass treatment compositions having at least one biosurfactant. This disclosure also relates to methods of enhancing the quality of turf grass by applying a turf grass treatment composition to the turf grass, or to roots of the turf grass, or to soil in which the turf grass grows.

### 2. Description of the Related Art

A wide variety of athletic, recreational, entertainment, commercial and residential venues utilize fields planted with turf grasses. Turf grasses, such as Kentucky bluegrass, Bent grass and Bermuda grass, are narrow-leaved grass species that grow and form a uniform ground cover. These species can typically tolerate being treaded on and being pruned or mowed to heights of, for example, a few inches or less.

The structure of turf grasses makes them ideal plants for athletics and recreation. The plants form horizontal stems, called stolons and rhizomes, that creep laterally above and below the ground, sprouting new plants and roots as they grow. Additionally, the lateral growth allows for cutting the grass as sod and rolling or stacking it so that it can be transported with ease.

An important turf grass quality is the ability of turf grass to withstand the negative effects of stress factors (e.g., droughts). Other important turf grass qualities include, for example, dense root structure and growth, nutrient use efficiency, water use efficiency, stress tolerance, and disease tolerance. Initial water uptake or wetting, rewetting and water retention over time are important qualities for a healthy turf grass.

Agricultural and horticultural compositions are typically used by farmers, gardeners, groundskeepers, etc. to maintain or improve plant health. The agricultural and horticultural compositions typically include active chemical ingredients and surfactants. Surfactants enable formulations to adhere to target surfaces and spread over a large area, facilitating wetting and movement of water. In spite of the known roles of surfactants in agricultural and horticultural formulations, fundamental surfactant studies in formulation preparation and optimization of biological efficacy are, to date, far from satisfactory.

In agricultural and horticultural formulations, a surfactant is crucial to enhance and optimize biological efficacy. However, such is an oversimplification. Selection of surfactant in an agricultural or horticultural formulation is critical because of the number of functions that must be performed. Moreover, due to the complex nature and lack of understanding of the mode of action of the active chemical, surfactant selection is often made by a trial and error procedures from an infinite number of possibilities, without predictability.

In agricultural and horticultural formulations, the vast majority of commercially available surfactants are synthetic products. There is a need for an eco-friendly biosurfactant product for agricultural and horticultural formulations that is comparable or better in performance to synthetic counterpart products, and to current organic options.

In particular, there is a need for an eco-friendly biosurfactant for turf grass treatment compositions that can enhance turf grass quality, especially stress tolerance or the ability of turf grass to withstand the negative effects of stress factors.

The present disclosure provides many advantages, including access to novel and exciting turf grass treatment compositions, which shall become apparent as described below.

### SUMMARY OF THE DISCLOSURE

This disclosure relates to turf grass treatment compositions having at least one biosurfactant. This disclosure also relates to methods of enhancing the quality of turf grass by applying a turf grass treatment composition to the turf grass, or to roots of the turf grass, or to soil in which the turf grass grows.

This disclosure relates in part to a turf grass treatment composition having at least one biosurfactant. The turf grass treatment composition, when applied to turf grass, or to roots of the turf grass, or to soil in which the turf grass grows, is effective for enhancing quality of the turf grass. The turf grass treatment composition optionally has at least one naturally-derived surfactant, at least one plant health component or biostimulant, and at least one inert component. The turf grass treatment composition enhances quality of the turf grass, for example, by enhancing root structure and growth, nutrient use efficiency, water use efficiency, stress tolerance, disease tolerance, and/or inducing systemic resistance.

This disclosure also relates in part to a method of enhancing quality of turf grass. The method involves applying to the turf grass, or to roots of the turf grass, or to soil in which the turf grass grows, a composition having at least one biosurfactant. The composition, when applied to turf grass, or to roots of the turf grass, or to soil in which the turf grass grows, is effective for enhancing quality of the turf grass. The turf grass treatment composition optionally has at least one naturally-derived surfactant, at least one plant health component or biostimulant, and at least one inert component. The turf grass treatment composition enhances quality of the turf grass, for example, by enhancing root structure and growth, nutrient use efficiency, water use efficiency, stress tolerance, disease tolerance, and/or inducing systemic resistance.

This disclosure further relates in part to a synergistic turf grass treatment composition having a synergistic combination of two or more biosurfactants. The synergistic combination of two or more biosurfactants, when applied to turf grass, or to roots of the turf grass, or to soil in which the turf grass grows, produces a combined turf grass quality effect, greater than the sum of the separate turf grass quality effects, at essentially the same concentrations. The synergistic turf grass treatment composition optionally has at least one naturally-derived surfactant, at least one plant health component or biostimulant, and at least one inert component. The turf grass quality effects include, for example, enhancing root structure and growth, nutrient use efficiency, water use efficiency, stress tolerance, disease tolerance, and/or inducing systemic resistance.

This disclosure yet further relates in part to a method of enhancing quality of turf grass. The method involves applying to the turf grass, or to roots of the turf grass, or to soil in which the turf grass grows, a synergistic composition comprising a synergistic combination of two or more biosurfactants. The synergistic combination of two or more biosurfactants, when applied to turf grass, or to roots of the turf grass, or to soil in which the turf grass grows, produces a combined turf grass quality effect, greater than the sum of the separate turf grass quality effects, at essentially the same concentrations. The synergistic turf grass treatment composition optionally has at least one naturally-derived surfactant, at least one plant health component or biostimulant, and at least one inert component. The turf grass quality effects include, for example, enhancing root structure and growth, nutrient use efficiency, water use efficiency, stress tolerance, disease tolerance, and/or inducing systemic resistance.

Further objects, features and advantages of the present disclosure will be understood by reference to the following detailed description.

### BRIEF DESCRIPTION OF THE DRAWINGS

FIG. 1 shows images of plots at the end of the trials that correspond to the experimental data in Table A, in accordance with the Examples.

FIG. 2 graphically depicts minimum and maximum temperature recorded during the trial period, in accordance with the Examples.

FIG. 3 graphically depicts precipitation recorded during the trial period, in accordance with the Examples.

FIG. 4 graphically depicts daily evapotranspiration (in) recorded during the trial period, in accordance with the Examples.

FIG. 5 shows field trial results for the treatment effect of F2-F14 formulations on turfgrass parameters, in accordance with the Examples.

FIG. 6 shows field trial results for the treatment effect of F2-F14 formulations on average bi-weekly turfgrass quality, in accordance with the Examples.

FIG. 7 shows field trial results for the treatment effect of F2-F14 formulations on average bi-weekly turfgrass color, in accordance with the Examples.

FIG. 8 shows field trial results for the treatment effect of F2-F14 formulations on average bi-weekly turfgrass NDVI, in accordance with the Examples.

FIG. 9 shows field trial results for the treatment effect of F2-F14 formulations on average bi-weekly surface firmness, in accordance with the Examples.

FIG. 10 shows field trial results for the treatment effect of F2-F14 formulations on average bi-weekly soil volumetric water content at 1.5 in, in accordance with the Examples.

FIG. 11 shows field trial results for the treatment effect of F2-F14 formulations on average bi-weekly soil moisture uniformity at 1.5 in. A lower value means more uniform water distribution in accordance with the Examples.

FIG. 12 shows field trial results for the treatment effect of F2-F14 formulations on average bi-weekly soil volumetric water content at 3 in, in accordance with the Examples.

FIG. 13 shows field trial results for the treatment effect of F2-F14 formulations on average bi-weekly soil moisture uniformity at 3 in. A lower value means more uniform water distribution, in accordance with the Examples.

FIG. 14 graphically depicts quality rating for turf treated with liquid surfactants, in accordance with the Examples.

FIG. 15 graphically depicts turf color rating for turf treated with granular surfactants, in accordance with the Examples.

FIG. 16 graphically depicts normalized difference vegetation index (NDVI) for turf treated with granular surfactants, in accordance with the Examples.

FIG. 17 graphically depicts volumetric water content (VWC) at 1.5″ depth for turf treated with liquid surfactants, in accordance with the Examples.

FIG. 18 graphically depicts volumetric water content (VWC) at 1.5″ depth for turf treated with granular surfactants, in accordance with the Examples.

FIG. 19 graphically depicts volumetric water content (VWC) at 3″ depth for turf treated with granular surfactants, in accordance with the Examples.

### DESCRIPTION OF THE PREFERRED EMBODIMENTS

This disclosure relates to quality, care, and maintenance of turf grasses in, for example, athletics and recreational settings. More specifically, this disclosure provides methods for enhancing the quality of turf grass. Advantageously, the methods are low-cost, utilize non-toxic substances, and can be implemented with ease by grounds-keeping employees with minimal additional training.

In an embodiment, this disclosure relates to a turf grass treatment compositions comprising at least one biosurfactant. The turf grass treatment compositions, when applied to turf grass, or to roots of the turf grass, or to soil in which the turf grass grows, are effective for enhancing quality of the turf grass. The turf grass treatment compositions can further comprise at least one naturally-derived surfactant, at least one plant health component or biostimulant, and at least one inert component.

Turf grass treatment compositional features and benefits include, for example, dual-action surfactant blend engineered to improve water infiltration and balanced hydration, turf grass health benefits, improved stress tolerance and turf grass quality, excellent localized dry spot (LDS) prevention, low spray volume ideal for broad acre applications, and/or outstanding dew suppression.

The concentration and ratio of ingredients in the turf grass treatment composition can be determined according to, for example, the species of turf grass being treated, the soil type where the turf grass is growing, the health of the turf grass at the time of treatment, as well as other factors. Thus, the turf grass treatment composition can be customizable for any given turf grass field.

### Biosurfactants

The turf grass treatment composition of this disclosure includes at least one biosurfactant. The biosurfactant is a growth byproduct of a microorganism. The microorganism is selected from bacteria, yeast, and fungi.

In accordance with this disclosure, a biosurfactant is a generally low molecular weight microbial product having effective surface activity. This includes lowering the surface and interfacial tension between different phases. For example, the phases include between two liquids, between a gas and a liquid, or between a liquid and a solid.

Advantageously, bacteria, yeasts, and fungi can be induced to produce biosurfactants. The bacteria, yeasts, and fungi can be genetically-modified (GM) or non-genetically-modified (non-GM).

As used herein, “biosurfactant” means a surfactant that exists in nature, or is produced by biological processes without any external inputs, or is produced by genetically-modified (GM) biological processes or non-genetically-modified (non-GM) biological processes. The biosurfactants used in the turf grass treatment compositions of this disclosure can be genetically-modified (GM) or non-genetically-modified (non-GM).

In an embodiment, the biosurfactant is selected from glycolipids, lipopeptides, phospholipids, fatty acids, polymeric surfactants, particulate surfactants, and combinations thereof. Preferred biosurfactants are glycolipids.

Glycolipids are lipids with a carbohydrate attached by a glycosidic bond. Illustrative glycolipids include rhamnolipid, sophorolipid, mannosylerythritol lipid, and trehalose lipid. A preferred glycolipid is rhamnolipid.

Rhamnolipid biosurfactants are naturally occurring extracellular glycolipids that are found in soil and on plants. Rhamnolipid biosurfactants contain rhamnose as the sugar moiety (hydrophilic) linked to beta-hydroxylated fatty acid chains (hydrophobic).

Rhamnolipid biosurfactants can be produced through microbial fermentation process of soy. Pseudomonas aeruginosa is the most competent microbe that can be induced to produce rhamnolipids. Rhamnolipid biosurfactant is recovered from the fermentation broth after sterilization and centrifugation, then purified to various levels to fit intended applications.

Sophorolipid biosurfactants are surface-active glycolipids that contain glucose-derived di-saccharide sophorose (hydrophilic) linked to fatty acid tail chain (hydrophobic).

Sophorolipid biosurfactants can be produced by a fermentation process of a number of non-pathogenic yeasts species, a gravity separation process, and an optional purification process.

The choice of yeast can influence distribution of lactone vs acidic forms of final molecule, and subsequently, performance. An example non-pathogenic yeast is Candida apicola, among others.

Polymeric surfactants are defined by the repeating units in the chemical structure, considered a high-mass biosurfactants. Non-limiting examples of polymeric biosurfactants include Emulsan, Liposan, Lipomanan, Alasan, Biodispersan and the like.

Lipopeptides are molecules having a lipid and a peptide, and have the unique ability to self-assemble into various structures. Non-limiting examples of lipopeptides biosurfactants include Surfactin, Lichenysin, and the like.

Surfactin is a bacterial cyclic lipopeptide. Surfactin biosurfactant has seven amino acids bonded to the carboxyl and hydroxy groups of the 14th-carbon fatty acid.

Surfactin biosurfactant can be produced by a bacterial cyclic lipopeptide and is recognized as one of the most effective biosurfactants, decreasing surface tension of water at rates as low as <0.01%.

Surfactin biosurfactant can be produced by submerged or solid-state fermentation processes followed by purification processes including membrane-based techniques, foam fractionation, extraction, adsorption, liquid membrane extraction, and combinations thereof.

Microorganisms Bacillus, Pseudomonas, or Candida can be induced to produce Surfactin. Advantageously, microorganisms can be paired with reaction type to optimize Surfactin output.

Fatty acids are carboxylic acids with long aliphatic, or carbon-hydrogen chains. Most fatty acids that are naturally occurring have an aliphatic chain containing an even number of carbon atoms, usually less than or equal to 30 carbon atoms. Fatty acid type is defined by the number of carbon atoms, even vs. odd number of carbon atoms, and saturation. Unsaturated fatty acids contain a minimum of one carbon-carbon double bond, hence influencing the molecule's properties.

Particulate surfactants are produced by Acinetobactor calcoaceticus, cyanobacteria, or Pseudomonas marginalis, among others. Particulate biosurfactants are another example of a high-mass biosurfactant due to their membrane vesicle or whole-cell structure.

Phospholipids are molecules that contain a hydrophilic phosphate head attached to two hydrophobic lipid tails, and are naturally produced by Acinetobactor sp., Aspergillus, and Corynebacterium lepus, among others. Phospholipids are most commonly known to be a primary component of biological membranes.

In an embodiment, the biosurfactant is produced by mechanical and biological processes without any chemical reaction that alters a molecule of the biosurfactant. Alternatively, the biosurfactant is produced from genetically-modified (GM) microorganisms or non-genetically-modified (non-GM) microorganisms.

In an embodiment, the microorganisms and biosurfactants useful according to this disclosure can be, for example, non-plant-pathogenic strains of bacteria, yeast, and/or fungi. These microorganisms may be natural or non-genetically modified, or genetically modified. The biosurfactants may be derived from natural or non-genetically modified, or genetically modified microorganisms. For example, the microorganisms may be transformed with specific genes to exhibit specific characteristics. The microorganisms may also be mutants of a desired strain. As used herein, “mutant” means a strain, genetic variant, or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In one embodiment, the microorganisms are capable of producing a biosurfactant. In another embodiment, biosurfactants can be produced separately by other microorganisms and added to the turf grass treatment composition, either in purified form or in crude form. Crude form biosurfactants can comprise, for example, biosurfactants and other products of cellular growth in the leftover fermentation medium resulting from cultivation of a biosurfactant-producing microbe. This crude form biosurfactant composition can comprise from about 0.001% to about 90%, about 25% to about 75%, about 30% to about 70%, about 35% to about 65%, about 40% to about 60%, about 45% to about 55%, or about 50% pure biosurfactant.

As amphiphilic molecules, microbial biosurfactants reduce the surface and interfacial tensions between the molecules of liquids, solids, and gases. Furthermore, the biosurfactants are biodegradable, have low toxicity, are effective in solubilizing and degrading insoluble compounds in turf grass and can be produced using low cost and renewable resources. They can inhibit adhesion of undesirable microorganisms to a variety of surfaces, prevent the formation of biofilms, and can have powerful emulsifying and demulsifying properties. Furthermore, the biosurfactants can be used to improve wettability and to achieve even solubilization and/or distribution of fertilizers, nutrients, and water in the turf grass.

The microorganisms useful in the turf grass treatment compositions may be in an active or inactive form, or in the form of vegetative cells, reproductive spores, mycelia, hyphae, conidia, or any other form of microbial propagule. The turf grass treatment composition may also contain a combination of any of these microbial forms.

While synthetic surfactants decrease surface tension, synthetic surfactants exhibit poor water uptake and water retention, particularly in turf grass treatment compositions as compared to biosurfactants in the turf grass treatment compositions of this disclosure.

In accordance with this disclosure, microbial biosurfactants, including glycolipids, polymeric surfactants, lipopeptides, fatty acids, particulate surfactants, phospholipids, and/or combinations thereof, exhibit superior performance in wettability and/or water retention, and other properties. These biosurfactants are readily soluble in water.

The biosurfactant can be in the form of a solid or a liquid.

In embodiments in which the biosurfactant is a solid, the solid optionally can be ground to a powder and directly mixed with the growing media at a selected application rate.

For example, the biosurfactant can be 100% glycolipid at 90% purity. The glycolipid can be rhamnolipid.

Additionally, the biosurfactant has a purity of at least 80%, at least 91%, at least 92%, at least 93%, and at least 95%. In yet other embodiments, glycolipid biosurfactant purity levels range from about 80% to about 98%, about 85 to about 96%, and about 92 to about 94%, including subranges therebetween. The glycolipid can be rhamnolipid.

The glycolipid can be solid rhamnolipid, which is a chunky dark red to brown material with irregular shaped granules up to approximately 5 mm diameter in size. By pulverization, a more uniform dispersion can be obtained.

In embodiments in which the biosurfactant is a liquid, the biosurfactant is prepared in a solution with water.

The liquid is at least about 18%, at least about 20%, at least about 22%, or at least about 24% glycolipid in solution with at least about 85%, about 90%, or about 95% purity. The glycolipid can be rhamnolipid.

The liquid can be between about 0.5% to about 50% biosurfactant in solution, preferably between about 10% to about 40%, and most preferably between about 18% to about 33%. In yet other embodiments, the liquid is between about 23% to about 27% biosurfactant in solution. The purity can be at least 80%, 81%, 82%, 83%, 84%, 85%, 86%, 87%, 88%, 89%, 90%, 91%, 92%, 93%, 94% or 95% purity.

The biosurfactant preferably has a purity of at least about 80% to about 95%. In yet other embodiments, glycolipid biosurfactant purity levels range between about 80% to 98%, preferably between about 85 to about 96%, and more preferably between about 92 to about 94%, including subranges therebetween. The glycolipid can be rhamnolipid.

Preferably, the concentration of biosurfactant in water is from about 0.1% by volume to about 50% by volume, more preferably from about 0.2% by volume to about 10% by volume, and most preferably from about 0.2% by volume to about 5% by volume.

The one or more biosurfactants are present in the turf grass treatment composition in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

### Naturally-Derived Surfactants

The turf grass treatment composition of this disclosure can optionally include at least one naturally-derived surfactant. As used herein, a “naturally-derived surfactant” is a surfactant produced from a naturally-derived source by mechanical and biological processes, and by a chemical reaction that alters a molecule of the naturally-derived source.

In an embodiment, the naturally-derived surfactant is selected from fatty acid derivatives, saponins, natural extracts, plant derived oils, lauric acid derivatives, and the like.

Illustrative naturally-derived surfactants include alkyl polyglucoside, Yucca extract, palm oil, coconut oil, sodium lauryl sulfate, and sodium coco sulfate. A preferred naturally-derived surfactant is alkyl polyglucoside.

The one or more naturally-derived surfactants are present in the turf grass treatment composition in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

In an embodiment, the weight ratio of the biosurfactant to the naturally-derived surfactant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

### Plant Health Component or Biostimulant

The turf grass treatment composition of this disclosure can optionally include at least one plant health component or biostimulant.

In an embodiment, the plant health component or biostimulant is selected from plant hormones, microbes selected from bacteria, yeast, and fungi; humic substances, seaweed extracts, protein hydrolysates, chitosan, inorganic compounds, and metabolites.

Illustrative plant health components or biostimulants include humic substances, humins, fulvic acids, fatty acids/lipids, peptides, amino acids, organic acids, carboxyls, B vitamins, protein hydrolysates, plant growth promoting bacteria (PGPR), cytokinins, Rhizobium, mycorrhizae, Trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

Illustrative yeast or fungi include Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffri), Mortierella, mycorrhizal fungi, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), and Zygosaccharomyces (e.g., Z. bailii).

Illustrative bacteria include Gram-positive and Gram-negative bacteria, rhizobacteria, Agrobacterium (e.g., A. radiobacter), Azotobacter (A. vinelandii, A. chroococcum), Azospirillum (e.g., A. brasiliensis), Bacillus (e.g., B. amyloliquifaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and Thiobacillus thiooxidans (Acidothiobacillus thiooxidans).

The microorganisms useful in the turf grass treatment compositions can be obtained through cultivation processes ranging from small to large scale. These cultivation processes include, but are not limited to, submerged cultivation/fermentation, solid state fermentation (SSF), and modifications, hybrids, and/or combinations thereof. In an embodiment, the microbes are cultivated using SSF or modifications thereof.

In an embodiment, the turf grass treatment composition of this disclosure is a microbe-based composition.

As used herein, a “microbe-based composition,” means a composition that comprises components that were produced as the result of the growth of microorganisms or other cell cultures. A microbe-based composition may comprise the microbes themselves and/or byproducts of microbial growth. The microbes may be in a vegetative state, in spore or conidia form, in hyphae form, in any other form of propagule, or a mixture of these. The microbes may be planktonic or in a biofilm form, or a mixture of both. The byproducts of growth may be, for example, metabolites, cell membrane components, expressed proteins, and/or other cellular components. The microbes may be intact or lysed. In an embodiment, the microbes are present, with growth medium in which they were grown, in the microbe-based composition. The microbes may be present at, for example, a concentration of at least 1×10⁴, 1×10⁵, 1×10⁶, 1×10⁷, 1×10⁸, 1×10⁹, 1×10¹⁰, 1×10¹¹, 1×10¹² or 1×10¹³ or more CFU per gram or per ml of the composition. In an embodiment, the turf grass treatment compositions of this disclosure can include about 0.1 to about 20% of the total composition by weight, or about 0.5 to 15%, or about 1 to about 12%.

The one or more plant health components or biostimulants are present in the turf grass treatment composition in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

In an embodiment, the weight ratio of the biosurfactant to the plant health component or biostimulant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

In another embodiment, the weight ratio of the plant health component or biostimulant to the naturally-derived surfactant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

### Biostimulants

As used herein, “biostimulants” are naturally-derived compounds that stimulate or accelerate turf grass growth when applied at low rates, and especially under stress conditions. Biostimulants include, but are not limited to, plant hormones, microbes (e.g., bacteria, yeast, and fungi), humic substances, seaweed extracts, protein hydrolysates, chitosan, inorganic compounds, and metabolites. Biostimulants do not include fertilizers, nutrients, or pesticides.

Biostimulants are based on natural raw materials, used in small amounts for the modification of physiological and biochemical plant processes that lead to the realization of genetic productive potential due to triggered hormonal changes, activation of metabolic processes, increase in efficiency of nutrition, stimulation of growth, development and strengthening the ability to withstand the negative effects of stress factors.

Biostimulants obtained from extracts and purified compounds of seaweed include, for example, the polysaccharides laminarin, alginates, and carrageenans, and their beakdown products; micro- and macronutrients; sterols; N-containing compounds such as betaines; and hormones. Seaweed extract hormones include, for example, auxins, cytokinins, gibberelins, abscisic acid, ethylene, elements (sodium (N), potassium (K), phosphorus (P), amino acids, micronutrients (Na, Ca, Fe, Mn, Zn, S, B, Mo, Cu).

The turf grass treatment compositions of this disclosure having at least one plant health component or biostimulant enable the turf grass treatment composition to enhance one or more qualities of turf grass.

Quality benefits of application of turf grass treatment compositions of this disclosure having seaweed extracts to turf grass include, for example, increased or enhanced: photosynthesis; photochemical activity; root enzyme activity; root mass; stress tolerance due to the production of superoxide dismutase enzymes; cytokinin activity under drying conditions to stimulate cell division; leaf moisture; α-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and microbiome.

Quality benefits of application of turf grass treatment compositions of this disclosure having protein hydrolysates and amino acids to turf grass include, for example, the following: makes the nutrients far more recognizable to the turf grass; limits temperature stress, drought stress, heavy metal stress, and low mowing heights; amino acid proline scavenges hydroxyl radicals by increasing superoxide dismutase (SOD); protein biosynthesis improvement; increased chlorophyll content; increased germination; stimulate carbon and nitrogen metabolism; and stimulate turf grass microbiomes.

Quality benefits of application of turf grass treatment compositions of this disclosure having chitosan to turf grass include, for example, enhanced or increased: leaf count, amino acid proline scavenges hydroxyl radicals by increasing superoxide dismutase (SOD); proline dehydrogenase production/stress adaption; chlorophyll content; germination; and vertical leaf growth.

Quality benefits of application of turf grass treatment compositions of this disclosure having inorganic compounds (e.g., aluminum (Al), cobalt (Co), sodium (Na), selenium (Se), and silicon (Si)) to turf grass include, for example: strengthening of cell walls by silica deposits; promoting turf grass growth; inducing tolerance to abiotic stress (drought, salinity, cold stress); inducing cell wall rigidification, osmoregulation, reduced transpiration; influencing osmotic, pH, and redox homeostasis; influencing hormone signaling and enzymes involved in stress response; and present in soils and turf grass as different inorganic salts.

Quality benefits of application of turf grass treatment compositions of this disclosure having silicon (Si) to turf grass include, for example: defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness and better ball roll.

Quality benefits of application of turf grass treatment compositions of this disclosure having microbes, bacteria (e.g., rhizobacteria (RB)) and fungi (e.g., mycorrhizal fungi (MF)) to turf grass include, for example, enhanced or increased: uptake of other macro- and micronutrients (RB, MF); root mass and surface area (RB); cytokinin content (RB); drought stress tolerance (MF, RB); arbuscule-forming mycorrhiza fungal may reduce Poa annua on greens (MF); chlorophyll content (MF, RB); absorption of mineral elements such as phosphorus (P), iron (Fe), copper (Cu), magnesium (Mg), potassium (K), boron (B), silicon (Si), sulfur (S), and nitrogen (N) (MF); above ground biomass (MF); water use efficiency (MF); less irrigation in summer (MF); and less artificial fertilizer for the same results (NMIF).

### Inert Component

The turf grass treatment composition of this disclosure can optionally include at least one inert component.

In an embodiment, the inert component is water.

The one or more inert components are present in the turf grass treatment composition in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

In an embodiment, the weight ratio of the biosurfactant to the inert component is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

In another embodiment, the weight ratio of the naturally-derived surfactant to the inert component is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

In yet another embodiment, the weight ratio of the plant health component or biostimulant to the inert component is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

### Other Additives

In some embodiments, the turf grass treatment compositions of this disclosure can include additional components, such as, for example, herbicides, fertilizers, pesticides, soil amendments, one or more sources of nutrients, and the like. Preferably, the additional components are non-toxic and environmentally-friendly. The exact materials and the quantities thereof can be determined by a groundskeeper or a turf scientist having the benefit of this disclosure.

To improve or stabilize the effects of the turf grass treatment composition, it can be blended with suitable adjuvants and then used as such or after dilution, if necessary. In certain embodiments, the turf grass treatment composition is formulated as a concentrated liquid preparation, or as dry powder or dry granules that can be mixed with water and other components to form a liquid product.

The methods can comprise applying materials to enhance microbe growth during application (e.g., adding nutrients to promote microbial growth). In one embodiment, the nutrient sources can include, for example, sources of magnesium, phosphate, nitrogen, potassium, selenium, calcium, sulfur, iron, copper, zinc, proteins, vitamins, and/or carbon.

In some embodiments, the methods of this disclosure comprise applying additional components, such as herbicides, fertilizers, pesticides, and/or soil amendments. Preferably, the additional components are non-toxic and environmentally-friendly. The exact materials and the quantities thereof can be determined by a groundskeeper or a turf scientist having the benefit of the subject disclosure, although the following compounds may be compatible with the methods of this disclosure:
antiscalants, such as, e.g., hydroxyethylidene diphosphonic acid;
bactericides, such as, e.g., streptomycin sulfate and/or Galltrol® (A. radiobacier strain K84);
biocides, such as, e.g., chlorine dioxide, didecyldimethyl ammonium chloride, halogenated heterocyclic, and/or hydrogen dioxide/peroxyacetic acid;
fertilizers, such as, e.g., N-P-K fertilizers, calcium ammonium nitrate 17-0-0, potassium thiosulfate, nitrogen (e.g., 10-34-0, Kugler KQ-XRN, Kugler KS-178C, Kugler KS-2075, Kugler LS 6-24-6S, UN 28, UN 32), and/or potassium;
fungicides, such as, e.g., chlorothalonil, manicozeb hexamethylenetetramine, aluminum tris, azoxystrobin, Bacillus spp. (e.g., B. licheniformis strain 3086, B. subtilis, B. subtilis strain QST 713), benomyl, boscalid, pyraclostrobin, captan, carboxin, chloroneb, chlorothalonil, copper culfate, cyazofamid, dicloran, dimethomorph, etridiazole, thiophanate-methyl, fenamidone, fenarimol, fludioxonil, fluopicolide, flutolanil, iprodione, mancozeb, maneb, mefanoxam, fludioxonil, mefenoxam, metalaxyl, myclobutanil, oxathiapiprolin, pentachloronitrobenzene (quintozene), phosphorus acid, propamocarb, propanil, pyraclostrobin, Reynoutria sachalinensis, Streptomyces spp. (e.g., S. griseoviridis strain K61, S. lydicus WYEC 108), sulfur, urea, thiabendazole, thiophanate methyl, thiram, triadimefon, triadimenol, and/or vinclozolin;
growth regulators, such as, e.g., ancymidol, chlormequat chloride, diaminozide, paclobutrazol, and/or uniconazole;
herbicides, such as, e.g., glyphosate, oxyfluorfen, and/or pendimethalin; insecticides, such as, e.g., acephate, azadirachtin, B. thuringiensis (e.g., subsp. israelensis strain AM 65-52), Beauveria bassiana (e.g., strain GHA), carbaryl, chlorpyrifos, cyantraniliprole, cyromazine, dicofol, diazinon, dinotefuran, imidacloprid, Isaria fumosorosae (e.g., Apopka strain 97), lindane, and/or malathion; water treatments, such as, e.g., hydrogen peroxide (30-35%), phosphonic acid (5-20%), and/or sodium chlorite;
as well as deet, citronella, essential oils, mineral oils, garlic extract, chili extract, and/or any known commercial and/or homemade additives that are determined to be compatible by the skilled artisan having the benefit of this disclosure.

### Quality of Turf Grass

The turf grass treatment compositions of this disclosure enhance the quality of turf grass. In accordance with this disclosure, the turf grass treatment composition, when applied to turf grass, or to roots of the turf grass, or to soil in which the turf grass grows, is effective for enhancing quality of the turf grass.

In an embodiment, the turf grass treatment composition of this disclosure, when applied to turf grass, or to roots of the turf grass, or to soil in which the turf grass grows, enhances quality of the turf grass by enhancing initial water uptake or wetting, rewetting, and/or water retention over time of the turf grass.

In an embodiment, the turf grass treatment composition of this disclosure, when applied to turf grass, or to roots of the turf grass, or to soil in which the turf grass grows, enhances quality of the turf grass by enhancing surface tension reduction, increasing speed to wet, increasing water retention, and/or increasing time to dry between watering events.

In an embodiment, the turf grass treatment composition of this disclosure, when applied to turf grass, or to roots of the turf grass, or to soil in which the turf grass grows, enhances quality of the turf grass by enhancing root structure and growth, nutrient use efficiency, water use efficiency, stress tolerance, disease tolerance, and/or inducing systemic resistance.

In an embodiment, the turf grass treatment composition of this disclosure, when applied to turf grass, or to roots of the turf grass, or to soil in which the turf grass grows, enhances quality of the turf grass by enhancing strength of the turf grass roots by increasing root density, increasing root diameter, and/or increasing root depth.

In an embodiment, the turf grass treatment composition of this disclosure, when applied to turf grass, or to roots of the turf grass, or to soil in which the turf grass grows, enhances quality of the turf grass by increasing or enhancing photosynthesis; photochemical activity; root enzyme activity; root mass; stress tolerance due to the production of superoxide dismutase enzymes; cytokinin activity under drying conditions to stimulate cell division; leaf moisture; α-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome.

In an embodiment, the turf grass treatment composition of this disclosure, when applied to turf grass, or to roots of the turf grass, or to soil in which the turf grass grows, enhances quality of the turf grass by making the nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes.

In an embodiment, the turf grass treatment composition of this disclosure, when applied to turf grass, or to roots of the turf grass, or to soil in which the turf grass grows, enhances quality of the turf grass by increasing or enhancing leaf count, amino acid proline scavenges hydroxyl radicals by increasing superoxide dismutase (SOD); proline dehydrogenase production/stress adaption; chlorophyll content; germination; and/or vertical leaf growth.

In an embodiment, the turf grass treatment composition of this disclosure, when applied to turf grass, or to roots of the turf grass, or to soil in which the turf grass grows, enhances quality of the turf grass by strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response.

In an embodiment, the turf grass treatment composition of this disclosure, when applied to turf grass, or to roots of the turf grass, or to soil in which the turf grass grows, enhances quality of the turf grass by providing defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness; and/or better ball roll.

In an embodiment, the turf grass treatment composition of this disclosure, when applied to turf grass, or to roots of the turf grass, or to soil in which the turf grass grows, enhances quality of the turf grass by increasing or enhancing uptake of macro- and micronutrients; root mass and surface area; cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur (S), and nitrogen (N); above ground biomass; water use efficiency; less irrigation in summer; and/or less artificial fertilizer for the same results.

In an embodiment, the turf grass treatment composition of this disclosure, when applied to turf grass, or to roots of the turf grass, or to soil in which the turf grass grows, enhances quality of the turf grass by enhancing health, growth, and/or sturdiness of the turf grass.

In an embodiment, the turf grass treatment composition of this disclosure, when applied to turf grass, or to roots of the turf grass, or to soil in which the turf grass grows, enhances quality of the turf grass by enhancing turf grass color, turf grass shoot density, and/or turf grass greenness.

### Turf Grasses

Any species of turf grass is useful in this disclosure. The turf grass treatment composition can be applied to turf grass, or to roots of the turf grass, or to soil in which the turf grass grows.

In an embodiment, the turf grass is in the form of sod comprised of turf grass and a layer of soil held together by the roots of the turf grass and forming a sheet.

In some embodiments, the turf grass is in the form of sod. As used herein, “sod” means sheets of turf grass comprising grass plants, their roots, and any soil that is attached thereto. The sheets can be harvested and transplanted to cover large surface areas of ground.

Illustrative turf grasses useful in this disclosure include, for example, the following: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); Zoysia grass (Zoysia spp.); Bahia grass (Paspalum notatum); carpet grass (Axonopus affinis); centipede grass (Eremochloa ophiuroides); kikuyu grass (Pennisetum clandesinum); seashore Paspalum (Paspalum vaginatum); Floratam (Stenotaphrum secundatum “Floratam”); blue gramma (Bouteloua gracilis); buffalo grass (Buchloe dactyloids); and/or sideoats gramma (Bouteloua curtipendula).

### Application Methods

As used herein, “applying” a turf grass treatment composition refers to contacting the turf grass treatment composition with a target or site such that the composition can have an effect on that target or site. The effect can be due to, for example, the action of the biosurfactant, or other components.

The turf grass treatment compositions of this disclosure can be contacted with a turf grass part. In an embodiment, the turf grass treatment composition is contacted with one or more roots of the turf grass. The turf grass treatment composition can be applied directly to the roots, e.g., by spraying or dunking the roots, and/or indirectly, e.g., by administering the turf grass treatment composition to the soil in which the turf grass grows (e.g., the rhizosphere). The turf grass treatment composition can be applied to the seeds of the turf grass prior to or at the time of planting, or to any other part of the turf grass and/or its surrounding environment.

Turf grass and/or its environments can be treated at any point during the process of cultivating the turf grass. For example, the turf grass treatment composition can be applied to the turf grass prior to, concurrently with, or after the time when seeds are planted. It can also be applied at any point thereafter during the development and growth of the turf grass.

In some embodiments, the methods of this disclosure can be implemented on turf grasses that are already planted and growing in soil, such as in fields, pitches, and pastures, and/or the methods can be implemented on turf grasses that have been, or will be, harvested as sod.

The turf grass treatment compositions of this disclosure can be applied to turf grass using an irrigation system.

In an embodiment, the turf grass treatment compositions of this disclosure can be applied to turf grass using a manual spreader. The spreader can be a broadcast spreader, a drop spreader, a handheld spreader, a handheld sprayer, or the like.

In an embodiment, the turf grass treatment compositions of this disclosure are applied to a field or pitch planted with the turf grass. The field can be used for athletics and/or recreation. The field can have commercial or residential uses.

In an embodiment, the field is a golf course, park, campground, amphitheater, horse track, soccer field, football field, lacrosse field, field hockey field, cricket field, rugby field, polo field, softball field, baseball field, or the like. The field can also be for commercial or residential uses.

In an embodiment, the turf grass treatment composition of this disclosure, when applied to turf grass, or to roots of the turf grass, or to soil in which the turf grass grows, helps prevent the occurrence of holes and/or divots in the field as a result of athletic or recreational use.

In an embodiment, the turf grass treatment composition of this disclosure, when applied to turf grass, or to roots of the turf grass, or to soil in which the turf grass grows, increases safety of participating in athletics or recreation on the field by preventing injuries caused by stepping in a hole and/or divot.

The methods of this disclosure can be implemented on turf grasses that are already growing in soil, such as in fields and pastures, and/or the methods can be implemented on turf grasses that have been, or will be, harvested as sod.

The methods of this disclosure can utilize standard equipment that is used for maintenance of turf grass fields. In one embodiment, the methods can comprise administering the composition into a tank connected to an irrigation system used for supplying water, fertilizers, pesticides, or other liquid compositions to a field. Thus, the turf grass and/or soil surrounding the turf grass can be treated with the composition via, for example, soil injection, soil drenching, or using a center pivot irrigation system, or with a spray over the seed furrow, or with sprinklers or drip irrigators. Advantageously, the method is suitable for treating hundreds of acres at one time.

In one embodiment, the methods can comprise pouring the turf grass treatment composition into the tank of a handheld lawn and garden sprayer and spraying turf grass and/or its surrounding environment with the mixture. The turf grass treatment composition can also be mixed into a standard handheld watering can and poured onto turf grass. Additionally, the turf grass treatment composition can be applied using a standard manual spreader, such as a broadcast spreader, a drop spreader, or a handheld spreader.

In certain embodiments, the turf grass treatment compositions provided herein are applied to the turf grass surface without mechanical incorporation. The beneficial effect of the turf grass application can be activated by rainfall, sprinkler, flood, or drip irrigation, and subsequently delivered to, for example, the roots of turf grass to influence the root microbiome and/or facilitate uptake of nutrients and water.

In one embodiment, the methods enhance the quality of turf grass by enhancing the root structure and growth, nutrient use efficiency, water use efficiency, stress tolerance, disease tolerance, and/or inducing systemic resistance.

In some embodiments, the methods work by, for example, improving the nutrient and moisture retention properties of the rhizosphere in which the turf grass grows. In some embodiments, the methods work by promoting colonization of the roots and/or rhizosphere with nutrient-fixing microbes, such as rhizobia and mycorrhizae.

The turf grass treatment compositions of this disclosure can be applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

### Synergistic Turf Grass Treatment Compositions and Methods

In an embodiment, this disclosure relates to synergistic turf grass treatment compositions comprising a synergistic combination of at least two biosurfactants. The synergistic turf grass treatment compositions having a synergistic combination of two or more biosurfactants, when applied to turf grass, or to roots of the turf grass, or to soil in which the turf grass grows, produces a combined turf grass quality effect, greater than the sum of the separate turf grass quality effects, at essentially the same concentrations. The synergistic turf grass treatment composition can further comprise at least one naturally-derived surfactant, at least one plant health component or biostimulant, and at least one inert component.

In an embodiment, this disclosure provides a method for enhancing quality of turf grass by applying to the turf grass, or to roots of the turf grass, or to soil in which the turf grass grows, a synergistic composition comprising a synergistic combination of two or more biosurfactants. The synergistic combination of two or more biosurfactants, when applied to turf grass, or to roots of the turf grass, or to soil in which the turf grass grows, produces a combined turf grass quality effect, greater than the sum of the separate turf grass quality effects, at essentially the same concentrations.

In an embodiment, the turf grass quality effect produced by the synergistic turf grass treatment compositions of this disclosure can include, for example, enhanced or increased initial water uptake or wetting, rewetting, and water retention over time of said turf grass.

In an embodiment, the turf grass quality effect produced by the synergistic turf grass treatment compositions of this disclosure can include, for example, surface tension reduction, increased speed to wet, increased water retention, and increased time to dry between watering events.

In an embodiment, the turf grass quality effect produced by the synergistic turf grass treatment compositions of this disclosure can include, for example, enhanced or increased root structure and growth, nutrient use efficiency, water use efficiency, stress tolerance, disease tolerance, and induced systemic resistance.

In an embodiment, the turf grass quality effect produced by the synergistic turf grass treatment compositions of this disclosure can include, for example, enhanced or increased strength of the turf grass roots by increasing root density, increased root diameter, and increased root depth.

In an embodiment, the turf grass quality effect produced by the synergistic turf grass treatment compositions of this disclosure can include, for example, enhanced or increased turf grass color, turf grass shoot density, and turf grass greenness.

Preferred embodiments of this disclosure are described in the clauses below.

1. A turf grass treatment composition comprising at least one biosurfactant; wherein the turf grass treatment composition, when applied to turf grass, or to roots of the turf grass, or to soil in which the turf grass grows, is effective for enhancing quality of the turf grass.

2. The turf grass treatment composition of clause 1 wherein the least one biosurfactant is a growth byproduct of a microorganism.

3. The turf grass treatment composition of clause 2 wherein the microorganism is a genetically-modified (GM) microorganism or a non-genetically (non-GM) modified microorganism.

4. The turf grass treatment composition of clause 2 wherein the microorganism is selected from the group consisting of bacteria, yeast, and fungi.

5. The turf grass treatment composition of clause 1 wherein the least one biosurfactant is selected from the group consisting of glycolipids, lipopeptides, phospholipids, fatty acids, and polymeric surfactants.

6. The turf grass treatment composition of clause 1 wherein the biosurfactant is a glycolipid.

7. The turf grass treatment composition of clause 1 wherein the biosurfactant is a glycolipid selected from the group consisting of rhamnolipid, sophorolipid, mannosylerythritol lipid, and trehalose lipid.

8. The turf grass treatment composition of clause 1 wherein the biosurfactant is rhamnolipid.

9. The turf grass treatment composition of clause 1 wherein the biosurfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

10. The turf grass treatment composition of clause 1 further comprising at least one naturally-derived surfactant.

11. The turf grass treatment composition of clause 10 wherein the at least one naturally-derived surfactant is selected from the group consisting of fatty acid derivatives, saponins, natural extracts, plant derived oils, and lauric acid derivatives.

12. The turf grass treatment composition of clause 10 wherein the at least one naturally-derived surfactant is selected from the group consisting of alkyl polyglucoside, Yucca extract, palm oil, coconut oil, sodium lauryl sulfate, and sodium coco sulfate.

13. The turf grass treatment composition of clause 10 wherein the at least one naturally-derived surfactant is alkyl polyglucoside.

14. The turf grass treatment composition of clause 10 wherein the naturally-derived surfactant is produced from a naturally-derived source by mechanical and biological processes, and by a chemical reaction that alters a molecule of the naturally-derived source.

15. The turf grass treatment composition of clause 10 wherein the naturally-derived surfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

16. The turf grass treatment composition of clause 10 wherein the weight ratio of the biosurfactant to the naturally-derived surfactant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

17. The turf grass treatment composition of clause 1 further comprising at least one plant health component or biostimulant.

18. The turf grass treatment composition of clause 17 wherein the at least one plant health component or biostimulant is selected from the group consisting of plant hormones, microbes selected from bacteria, yeast, and fungi; humic substances, seaweed extracts, protein hydrolysates, chitosan, inorganic compounds, and metabolites.

19. The turf grass treatment composition of clause 17 wherein the at least one plant health component or biostimulant is selected from the group consisting of humic substances, humins, fulvic acids, fatty acids/lipids, peptides, amino acids, organic acids, carboxyls, B vitamins, protein hydrolysates, plant growth promoting bacteria (PGPR), cytokinins, Rhizobium, mycorrhizae, Trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

20. The turf grass treatment composition of clause 18 wherein the yeast or fungi are selected from the group consisting of Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffri), Mortierella, mycorrhizal fungi, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), and Zygosaccharomyces (e.g., Z. bailii).

21. The turf grass treatment composition of clause 18 wherein the bacteria are selected from the group consisting of Gram-positive and Gram-negative bacteria, rhizobacteria, Agrobacterium (e.g., A. radiobacter), Azotobacter (A. vinelandii, A. chroococcum), Azospirillum (e.g., A. brasiliensis), Bacillus (e.g., B. amyloliquifaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and Thiobacillus thiooxidans (Acidothiobacillus thiooxidans).

22. The turf grass treatment composition of clause 17 wherein the plant health component or biostimulant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

23. The turf grass treatment composition of clause 17 wherein the weight ratio of the biosurfactant to the plant health component or biostimulant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

24. The turf grass treatment composition of clause 17 wherein the weight ratio of the plant health component or biostimulant to the naturally-derived surfactant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

25. The turf grass treatment composition of clause 1 further comprising at least one inert component.

26. The turf grass treatment composition of clause 25 wherein the at least one inert component comprises water.

27. The turf grass treatment composition of clause 25 wherein the at least one inert component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

28. The turf grass treatment composition of clause 25 wherein the weight ratio of the biosurfactant to the inert component is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

29. The turf grass treatment composition of clause 25 wherein the weight ratio of the naturally-derived surfactant to the inert component is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

30. The turf grass treatment composition of clause 25 wherein the weight ratio of the plant health component or biostimulant to the inert component is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

31. The turf grass treatment composition of clause 1 which, when applied to turf grass, or to roots of the turf grass, or to soil in which the turf grass grows, enhances quality of the turf grass by enhancing initial water uptake or wetting, rewetting, and/or water retention overtime of said turf grass.

32. The turf grass treatment composition of clause 1 which, when applied to turf grass, or to roots of the turf grass, or to soil in which the turf grass grows, enhances quality of the turf grass by enhancing surface tension reduction, increasing speed to wet, increasing water retention, and/or increasing time to dry between watering events.

33. The turf grass treatment composition of clause 1 which, when applied to turf grass, or to roots of the turf grass, or to soil in which the turf grass grows, enhances quality of the turf grass by enhancing root structure and growth, nutrient use efficiency, water use efficiency, stress tolerance, disease tolerance, and/or inducing systemic resistance.

34. The turf grass treatment composition of clause 1 which, when applied to turf grass, or to roots of the turf grass, or to soil in which the turf grass grows, enhances quality of the turf grass by enhancing strength of the turf grass roots by increasing root density, increasing root diameter, and/or increasing root depth.

35. The turf grass treatment composition of clause 1 which, when applied to turf grass, or to roots of the turf grass, or to soil in which the turf grass grows, enhances quality of the turf grass by increasing or enhancing photosynthesis; photochemical activity; root enzyme activity; root mass; stress tolerance due to the production of superoxide dismutase enzymes; cytokinin activity under drying conditions to stimulate cell division; leaf moisture; α-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome.

36. The turf grass treatment composition of clause 1 which, when applied to turf grass, or to roots of the turf grass, or to soil in which the turf grass grows, enhances quality of the turf grass by making the nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes.

37. The turf grass treatment composition of clause 1 which, when applied to turf grass, or to roots of the turf grass, or to soil in which the turf grass grows, enhances quality of the turf grass by increasing or enhancing leaf count, amino acid proline scavenges hydroxyl radicals by increasing superoxide dismutase (SOD); proline dehydrogenase production/stress adaption; chlorophyll content; germination; and/or vertical leaf growth.

38. The turf grass treatment composition of clause 1 which, when applied to turf grass, or to roots of the turf grass, or to soil in which the turf grass grows, enhances quality of the turf grass by strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response.

39. The turf grass treatment composition of clause 1 which, when applied to turf grass, or to roots of the turf grass, or to soil in which the turf grass grows, enhances quality of the turf grass by providing defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness; and/or better ball roll.

40. The turf grass treatment composition of clause 1 which, when applied to turf grass, or to roots of the turf grass, or to soil in which the turf grass grows, enhances quality of the turf grass by increasing or enhancing uptake of macro- and micronutrients; root mass and surface area; cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur (S), and nitrogen (N); above ground biomass; water use efficiency; less irrigation in summer; and/or less artificial fertilizer for the same results.

41. The turf grass treatment composition of clause 1 which, when applied to turf grass, or to roots of the turf grass, or to soil in which the turf grass grows, enhances quality of the turf grass by enhancing health, growth, and/or sturdiness of the turf grass.

42. The turf grass treatment composition of clause 1 which, when applied to turf grass, or to roots of the turf grass, or to soil in which the turf grass grows, enhances quality of the turf grass by enhancing turf grass color, turf grass shoot density, and/or turf grass greenness.

43. The turf grass treatment composition of clause 1 wherein the turf grass is selected from the group consisting of: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); Zoysia grass (Zoysia spp.); Bahia grass (Paspalum notatum); carpet grass (Axonopus affinis); centipede grass (Eremochloa ophiuroides); kikuyu grass (Pennisetum clandesinum); seashore Paspalum (Paspalum vaginatum); floratam (Stenotaphrum secundatum “Floratam”); blue gramma (Bouteloua gracilis); buffalo grass (Buchloe dactyloids); and/or sideoats gramma (Bouteloua curtipendula).

44. The turf grass treatment composition of clause 1 which is applied to turf grass using an irrigation system.

45. The turf grass treatment composition of clause 1 which is applied to turf grass using a manual spreader, said spreader comprising a broadcast spreader, a drop spreader, a handheld spreader, or a handheld sprayer.

46. The turf grass treatment composition of clause 1 wherein the turf grass is in the form of sod comprising turf grass and a layer of soil held together by the roots of the turf grass and forming a sheet.

47. The turf grass treatment composition of clause 1 wherein the composition is applied to a field or pitch planted with the turf grass.

48. The turf grass treatment composition of clause 47 wherein the field is used for athletics and/or recreation.

49. The turf grass treatment composition of clause 47 wherein the field is a park, campground, amphitheater, golf course, horse track, soccer field, football field, lacrosse field, field hockey field, cricket field, rugby field, polo field, softball field or baseball field.

50. The turf grass treatment composition of clause 47 which, when applied to turf grass, or to roots of the turf grass, or to soil in which the turf grass grows, helps prevent the occurrence of holes and/or divots in the field as a result of athletic or recreational use.

51. The turf grass treatment composition of clause 1 which, when applied to turf grass, or to roots of the turf grass, or to soil in which the turf grass grows, increases safety of participating in athletics or recreation on the field by preventing injuries caused by stepping in a hole and/or divot.

52. The turf grass treatment composition of clause 1 which is a microbe-based composition.

53. The turf grass treatment composition of clause 1 which is applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

54. A synergistic turf grass treatment composition comprising a synergistic combination of two or more biosurfactants; wherein the synergistic combination of two or more biosurfactants, when applied to turf grass, or to roots of the turf grass, or to soil in which the turf grass grows, produces a combined turf grass quality effect, greater than the sum of the separate turf grass quality effects, at essentially the same concentrations.

55. The synergistic turf grass treatment composition of clause 54 wherein the turf grass quality effect is selected from the group consisting of enhanced or increased initial water uptake or wetting, rewetting, and water retention over time of said turf grass.

56. The synergistic turf grass treatment composition of clause 54 wherein the turf grass quality effect is selected from the group consisting of surface tension reduction, increased speed to wet, increased water retention, and increased time to dry between watering events.

57. The synergistic turf grass treatment composition of clause 54 wherein the turf grass quality effect is selected from the group consisting of enhanced or increased root structure and growth, nutrient use efficiency, water use efficiency, stress tolerance, disease tolerance, and induced systemic resistance.

58. The synergistic turf grass treatment composition of clause 54 wherein the turf grass quality effect is selected from the group consisting of enhanced or increased strength of the turf grass roots by increasing root density, increased root diameter, and increased root depth.

59. The synergistic turf grass treatment composition of clause 1 wherein the turf grass quality effect is selected from the group consisting of enhanced or increased turf grass color, turf grass shoot density, and turf grass greenness.

60. A method of enhancing quality of turf grass, said method comprising: applying to the turf grass, or to roots of the turf grass, or to soil in which the turf grass grows, a composition comprising at least one biosurfactant; wherein the composition, when applied to turf grass, or to roots of the turf grass, or to soil in which the turf grass grows, is effective for enhancing quality of the turf grass.

61. The method of clause 60 wherein the composition is applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

62. The method of clause 60 which, when the composition is applied to the turf grass, or to roots of the turf grass, or to soil in which the turf grass grows, enhances quality of the turf grass by enhancing initial water uptake or wetting, rewetting, and/or water retention overtime of said turf grass.

63. The method of clause 60 which, when the composition is applied to turf grass, or to roots of the turf grass, or to soil in which the turf grass grows, enhances quality of the turf grass by enhancing surface tension reduction, increasing speed to wet, increasing water retention, and/or increasing time to dry between watering events.

64. The method of clause 60 which, when the composition is applied to the turf grass, or to roots of the turf grass, or to soil in which the turf grass grows, enhances quality of the turf grass by enhancing root structure and growth, nutrient use efficiency, water use efficiency, stress tolerance, disease tolerance, and/or induced systemic resistance.

65. The method of clause 60 which, when the composition is applied to the turf grass, or to roots of the turf grass, or to soil in which the turf grass grows, enhances quality of the turf grass by enhancing strength of the turf grass roots by increasing root density, increasing root diameter, and/or increasing root depth.

66. The method of clause 60 which, when the composition is applied to the turf grass, or to roots of the turf grass, or to soil in which the turf grass grows, enhances quality of the turf grass by increasing or enhancing photosynthesis; photochemical activity; root enzyme activity; root mass; stress tolerance due to the production of superoxide dismutase enzymes; cytokinin activity under drying conditions to stimulate cell division; leaf moisture; α-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome.

67. The method of clause 60 which, when the composition is applied to the turf grass, or to roots of the turf grass, or to soil in which the turf grass grows, enhances quality of the turf grass by making nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes.

68. The method of clause 60 which, when the composition is applied to the turf grass, or to roots of the turf grass, or to soil in which the turf grass grows, enhances quality of the turf grass by increasing or enhancing leaf count, amino acid proline scavenges hydroxyl radicals by increasing superoxide dismutase (SOD); proline dehydrogenase production/stress adaption; chlorophyll content; germination; and/or vertical leaf growth.

69. The method of clause 60 which, when the composition is applied to the turf grass, or to roots of the turf grass, or to soil in which the turf grass grows, enhances quality of the turf grass by strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response.

70. The method of clause 60 which, when the composition is applied to the turf grass, or to roots of the turf grass, or to soil in which the turf grass grows, enhances quality of the turf grass by providing defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness and/or better ball roll.

71. The method of clause 60 which, when the composition is applied to the turf grass, or to roots of the turf grass, or to soil in which the turf grass grows, enhances quality of the turf grass by increasing or enhancing uptake of macro- and micronutrients; root mass and surface area; cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur (S), and nitrogen (N); above ground biomass; water use efficiency; less irrigation in summer; and/or less artificial fertilizer for the same results.

72. The method of clause 60 which, when the composition is applied to the turf grass, or to roots of the turf grass, or to soil in which the turf grass grows, enhances quality of the turf grass by enhancing health, growth, and/or sturdiness of the turf grass.

73. The method of clause 60 which, when the composition is applied to turf grass, or to roots of the turf grass, or to soil in which the turf grass grows, enhances quality of the turf grass by enhancing turf grass color, turf grass shoot density, and/or turf grass greenness.

74. The method of clause 60 wherein the least one biosurfactant is a growth byproduct of a microorganism.

75. The method of clause 74 wherein the microorganism is a genetically-modified (GM) microorganism or a non-genetically (non-GM) modified microorganism.

76. The method of clause 74 wherein the microorganism is selected from the group consisting of bacteria, yeast, and fungi.

77. The method of clause 60 wherein the least one biosurfactant is selected from the group consisting of glycolipids, lipopeptides, phospholipids, fatty acids, and polymeric surfactants.

78. The method of clause 60 wherein the biosurfactant is a glycolipid.

79. The method of clause 60 wherein the biosurfactant is a glycolipid selected from the group consisting of rhamnolipid, sophorolipid, mannosylerythritol lipid, and trehalose lipid.

80. The method of clause 60 wherein the biosurfactant is rhamnolipid.

81. The method of clause 60 wherein the biosurfactant is produced by mechanical and biological processes without any chemical reaction that alters a molecule of the biosurfactant.

82. The method of clause 60 wherein the biosurfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the composition.

83. The method of clause 60 wherein the composition further comprises at least one naturally-derived surfactant.

84. The method of clause 83 wherein the at least one naturally-derived surfactant is selected from the group consisting of fatty acid derivatives, saponins, natural extracts, plant derived oils, and lauric acid derivatives.

85. The method of clause 83 wherein the at least one naturally-derived surfactant is selected from the group consisting of alkyl polyglucoside, Yucca extract, palm oil, coconut oil, sodium lauryl sulfate, and sodium coco sulfate.

86. The method of clause 83 wherein the at least one naturally-derived surfactant is alkyl polyglucoside.

87. The method of clause 83 wherein the naturally-derived surfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the composition.

88. The method of clause 83 wherein the weight ratio of the biosurfactant to the naturally-derived surfactant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

89. The method of clause 60 wherein the composition further comprises at least one plant health component or biostimulant.

90. The method of clause 89 wherein the at least one plant health component or biostimulant is selected from the group consisting of plant hormones, microbes selected from bacteria, yeast, and fungi; humic substances, seaweed extracts, protein hydrolysates, chitosan, inorganic compounds, and metabolites.

91. The method of clause 89 wherein the at least one plant health component or biostimulant is selected from the group consisting of humic substances, humins, fulvic acids, fatty acids/lipids, peptides, amino acids, organic acids, carboxyls, B vitamins, protein hydrolysates, plant growth promoting bacteria (PGPR), cytokinins, Rhizobium, mycorrhizae, Trichoderma, fungi, microbial complex communities/consortia, phytohormones, seaweed/kelp, laminarin, alginates, polysaccharides, polyphenols, botanicals, allelochemicals, organic matter extracts, chitin, chitosan, betaines, polyamines, inorganic salts, proteins, elements selected from silicon (Si), sodium (Na) and cobalt (Co), phosphites, nitrogeneous compounds, and enzymatic extracts.

92. The method of clause 89 wherein the yeast or fungi are selected from the group consisting of Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffri), Mortierella, mycorrhizal fungi, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), and Zygosaccharomyces (e.g., Z. bailii).

93. The method of clause 89 wherein the bacteria are selected from the group consisting of Gram-positive and Gram-negative bacteria, rhizobacteria, Agrobacterium (e.g., A. radiobacter), Azotobacter (A. vinelandii, A. chroococcum), Azospirillum (e.g., A. brasiliensis), Bacillus (e.g., B. amyloliquifaciens, B. circulans, B. firmus, B. laterosporus, B. licheniformis, B. megaterium, Bacillus mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and Thiobacillus thiooxidans (Acidothiobacillus thiooxidans).

94. The method of clause 89 wherein the plant health component or biostimulant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the composition.

95. The method of clause 89 wherein the weight ratio of the biosurfactant to the plant health component or biostimulant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

96. The method of clause 89 wherein the weight ratio of the plant health component or biostimulant to the naturally-derived surfactant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

97. The method of clause 60 wherein the composition further comprises at least one inert component.

98. The method of clause 97 wherein the at least one inert component comprises water.

99. The method of clause 97 wherein the at least one inert component is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the composition.

100. The method of clause 97 wherein the weight ratio of the biosurfactant to the inert component is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

101. The method of clause 97 wherein the weight ratio of the naturally-derived surfactant to the inert component is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

102. The method of clause 97 wherein the weight ratio of the plant health component or biostimulant to the inert component is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

103. The method of clause 60 wherein the turf grass is selected from the group consisting of annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); Zoysia grass (Zoysia spp.); Bahia grass (Paspalum notatum); carpet grass (Axonopus affinis); centipede grass (Eremochloa ophiuroides); kikuyu grass (Pennisetum clandesinum); seashore Paspalum (Paspalum vaginatum); floratam (Stenotaphrum secundatum “Floratam”); blue gramma (Bouteloua gracilis); buffalo grass (Buchloe dactyloids); and/or sideoats gramma (Bouteloua curtipendula).

104. The method of clause 60 wherein the composition is applied to turf grass using an irrigation system.

105. The method of clause 60 wherein the composition is applied to turf grass using a manual spreader, said spreader comprising a broadcast spreader, a drop spreader, a handheld spreader, or a handheld sprayer.

106. The method of clause 60 wherein the turf grass is in the form of sod comprising turf grass and a layer of soil held together by the roots of the turf grass and forming a sheet.

107. The method of clause 60 wherein the composition is applied to a field or pitch planted with the turf grass.

108. The method of clause 107 wherein the field is used for athletics and/or recreation.

109. The method of clause 107 wherein the field is a park, campground, amphitheater, golf course, horse track, soccer field, football field, lacrosse field, field hockey field, cricket field, rugby field, polo field, softball field or baseball field.

110. The method of clause 60 which, when the composition is applied to turf grass, or to roots of the turf grass, or to soil in which the turf grass grows, helps prevent the occurrence of holes and/or divots in the field as a result of athletic or recreational use.

111. The method of clause 60 which, when the composition is applied to turf grass, or to roots of the turf grass, or to soil in which the turf grass grows, increases safety of participating in athletics or recreation on the field by preventing injuries caused by stepping in a hole and/or divot.

112. The method of clause 60 wherein the composition is a microbe-based composition.

113. A method of enhancing quality of turf grass, said method comprising: applying to the turf grass, or to roots of the turf grass, or to soil in which the turf grass grows, a synergistic composition comprising a synergistic combination of two or more biosurfactants; wherein the synergistic combination of two or more biosurfactants, when applied to turf grass, or to roots of the turf grass, or to soil in which the turf grass grows, produces a combined turf grass quality effect, greater than the sum of the separate turf grass quality effects, at essentially the same concentrations.

114. The method of clause 113 wherein the turf grass quality effect is selected from the group consisting of enhanced or increased water uptake or wetting, rewetting, and water retention over time of said turf grass.

115. The method of clause 113 wherein the turf grass quality effect is selected from the group consisting of surface tension reduction, increased speed to wet, increased water retention, and increased time to dry between watering events.

116. The method of clause 113 wherein the turf grass quality effect is selected from the group consisting of enhanced or increased root structure and growth, nutrient use efficiency, water use efficiency, stress tolerance, disease tolerance, and induced systemic resistance.

117. The method of clause 113 wherein the turf grass quality effect is selected from the group consisting of increased strength of the turf grass roots by increasing root density, increased root diameter, and increased root depth.

118. The method of clause 113 wherein the turf grass quality effect is selected from the group consisting of enhanced or increased turf grass color, turf grass shoot density, and turf grass greenness.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

While the present disclosure has been described with reference to one or more exemplary embodiments, it will be understood by those skilled in the art, that various changes can be made, and equivalents can be substituted for elements thereof without departing from the scope of the present disclosure. In addition, many modifications can be made to adapt a particular situation or material to the teachings of the present disclosure without departing from the scope thereof. Therefore, it is intended that the present disclosure will not be limited to the particular embodiments disclosed herein, but that the disclosure will include all aspects falling within the scope of a fair reading of appended claims.

The following examples are only to illustrate embodiments according to the disclosure. The disclosure is not limited thereto.

### EXAMPLES

### Example 1

Trials were conducted on an established Tif-Eagle (Cynodon dactylon vs transvaalensis) green, managed as fine turf, and established at USGA specification. The trials ran for 60-90 days during summer months.

The trials were laid out in a randomized block design with 4 replicates of each treatment. Treatments were applied at the beginning of the experiment once per month for a total of 3 treatment applications. Experimental plots measured 1×1 m with a buffer of 10 cm within each plot. Irrigation was applied within 24 hours after each application. Applications rates were Zipline 8 oz/1000 ft² and Astria 4 oz/1000 ft², each monthly. Zipline is a commercially available turf grass treatment composition outside the scope of this disclosure. Zipline was used for comparative purposes. Astria is a turf grass treatment composition of this disclosure.

Drought was enforced after treatments were applied and irrigated so that moisture deficit could be elicited followed by an irrigated recovery period.
Time 1—1st assessment and treatments application—in good irrigation
Time 2—2nd assessment—in drought
Time 3—3rd assessment and second application—in good irrigation
Time 4—4th assessment—in drought
Time 5—5th assessment and third reapplication—in good irrigation

Assessments were conducted as follows:
Turf Color—visually assessed on a scale from 1-10
Turf Quality—visually assessed on a scale from 1-10
NDVI—the normalized difference vegetation index measure of greenness was assessed using a handheld NDVI meter.
Sward Density—turf density refers to the number of shoots per unit area and high density contributes to high visual quality of turf stands. It can also be understood as percent turf coverage within the plot.

Results from the trials are shown in Table A below.
Turf Color—Zipline and Astria exhibited better color than the untreated control.
Turf Quality—Zipline and Astria exhibited better quality than the untreated control.
NDVI—All treatments exhibited similar level of greenness.
Sward Density—Zipline and Astria exhibited better sward density than the untreated control.

TABLE A

| Treatment* | Color | NDVI | Quality | Sward Density |
|---|---|---|---|---|
| Untreated | 6.9a | 6.5a | 6.3a | 93a |
| Zipline | 7.6b | 6.7a | 7.8c | 98b |
| Astria | 7.3b | 6.6a | 7.0b | 97b |

*Means followed by the same letter are not significantly different; Anova <0.05, LSD α = 0.05. SAS Vol. 2.

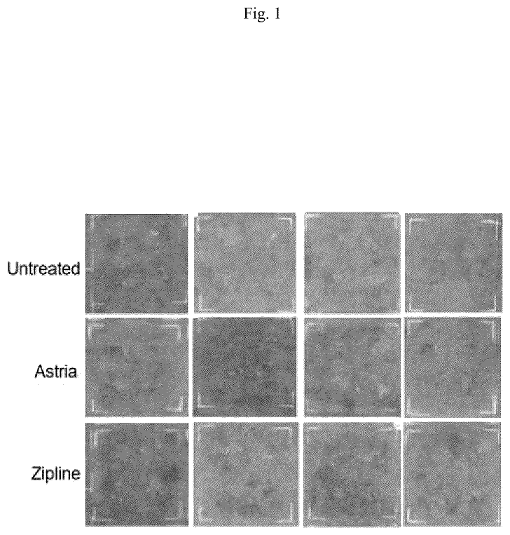

FIG. 1 shows images of plots at the end of the trials that correspond to the experimental data in Table A above.

### Example 2

Field trials were conducted on 8 year old Tif-Eagle (Cynodon dactylon vs transvaalensis) ultradwarf bermudagrass green to evaluate the performance of granular and/or naturally derived formulations of this disclosure compared to industry standard soil surfactants.

Treatment applications started on February 14 in Fort Lauderdale, Florida and were repeated every two weeks thereafter for a total of 7 applications. All treatments were applied in the morning using a 2-nozzle CO₂ boom type sprayer set to deliver 2 gallon/1000 ft² and watered in at 0.25 in after application. Four replications of 5′×5′ plots in a randomized complete block (RCB) design were used for the trial. Area was fertilized weekly with ammonium sulfate (21-0-0) at a rate of 0.125 lb N/1000 ft². Turf was mowed three times per week during the winter and five times during the spring at 0.12 in with clippings collected. Area was irrigated daily at 80% evapotranspiration (Eto) from February 12 to March 12, at 50% ETo from March 13 to April 22, and at 100% ETo from April 23 to May 22. The area was aerified on March 8, using with needle tines followed by topdressing using 90:10 (sand:peat). Weather data was retrieved from Florida Automated Weather Network (FAWN) weather station located 1000 ft away from the experiment.

Data was collected every two weeks. Turf quality was measured in a scale of 1-9 with 9=dark green dense turf, 1=dead/brown turf, and 6=minimally acceptable turf, turf color was measured on a scale of 1-9 with 9=green, 1=brown, and 6=minimally acceptable, NDVI was measured using a handheld meter, surface firmness was measured using a turf firmness meter and was analyzed as an average of three readings per plot, VWC was measured at a 1.5 and 3 inches using a time domain reflectance sensor and was analyzed as an average of six readings per plot. Additionally, standard deviation from the mean was calculated to estimate soil moisture uniformity. Data was subject to statistical analysis to determine treatment effect.

The product formulations used in the field trials included the following:
F2 Formulation—commercial synthetic product; surfactant system with plant health benefit
F3 Formulation—commercial synthetic product; surfactant system with plant health benefit
F4 Formulation—commercial synthetic product; surfactant system with plant health benefit
F5 Formulation—naturally-derived liquid product; liquid sophorolipid surfactant system with plant health benefit
F6 Formulation—naturally-derived liquid product; liquid sophorolipid surfactant system with plant health benefit
F7 Formulation—commercial synthetic product; surfactant system with plant health benefit
F8 Formulation—commercial synthetic product; surfactant system with plant health benefit
F9 Formulation—commercial synthetic product; surfactant system with plant health benefit
F10 Formulation—commercial synthetic product; surfactant system with plant health benefit
F11 Formulation—naturally-derived product; liquid rhamnolipid surfactant system on paper granule with plant health benefit
F12 Formulation—naturally-derived product; liquid rhamnolipid surfactant system on compost granule with plant health benefit
F13 Formulation—naturally-derived product; liquid sophorolipid surfactant system on compost granule with plant health benefit
F14 Formulation—naturally-derived product; liquid sophorolipid surfactant system on compost granule with plant health benefizt

The application rate and application interval of the product formulations used in the field trials are set forth in the table below.

| Formulation | Rate | | Application |
|---|---|---|---|
| Code | (fl oz/M) | | interval |
| C | — | | — |
| F2 Formulation | 3 | fl oz/M | 14 days |
| F3 Formulation | 3 | fl oz/M | 14 days |
| F4 Formulation | 3 | fl oz/M | 14 days |
| F5 Formulation | 3 | fl oz/M | 14 days |
| F6 Formulation | 3 | fl oz/M | 14 days |
| F7 Formulation | 0.47 | fl oz/M | 30 days |
| F8 Formulation | 3 | fl oz/M | 14 days |
| F9 Formulation | 3 | fl oz/M | 14 days |
| F10 Formulation | 3 | fl oz/M | 14 days |
| F11 Formulation | 2.5 | lb/M | 14 days |
| F12 Formulation | 2.5 | lb/M | 14 days |
| F13 Formulation | 2.5 | lb/M | 14 days |
| F14 Formulation | 2.5 | lb/M | 14 days |

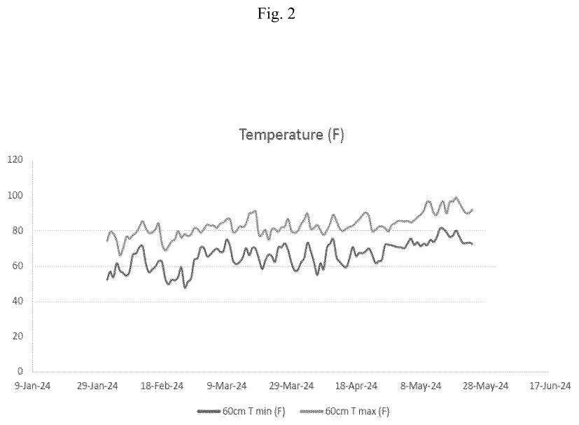

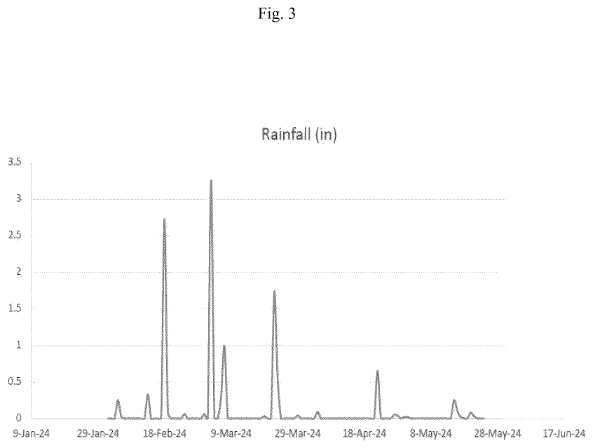

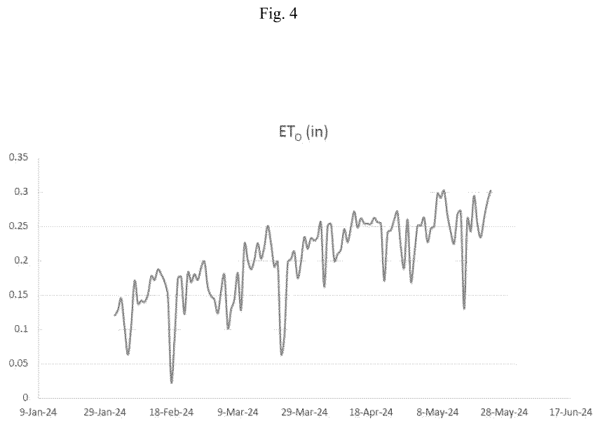

The meteorological conditions during the field trials were recorded. FIG. 2 graphically depicts minimum and maximum temperature recorded during the trial period. FIG. 3 graphically depicts precipitation recorded during the trial period. FIG. 4 graphically depicts daily evapotranspiration (in) recorded during the trial period.

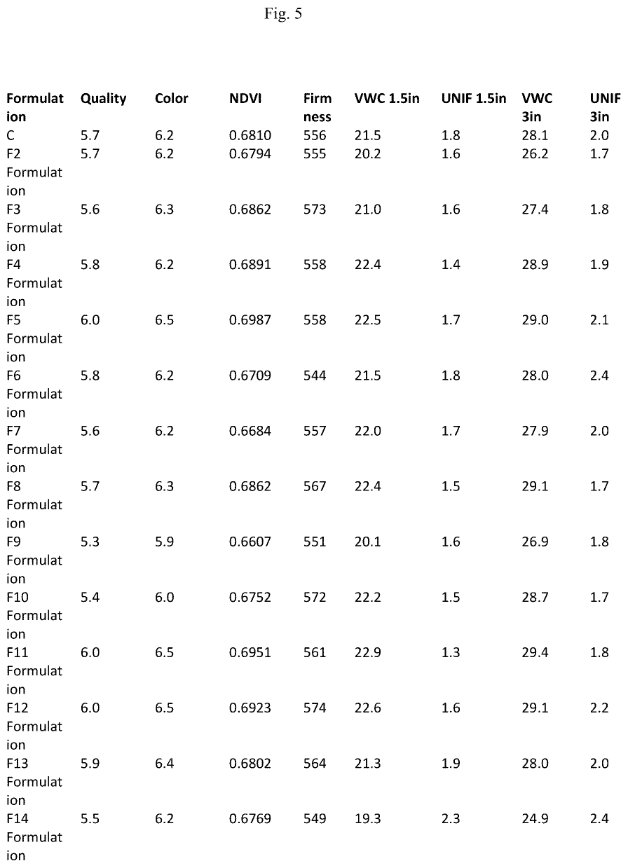

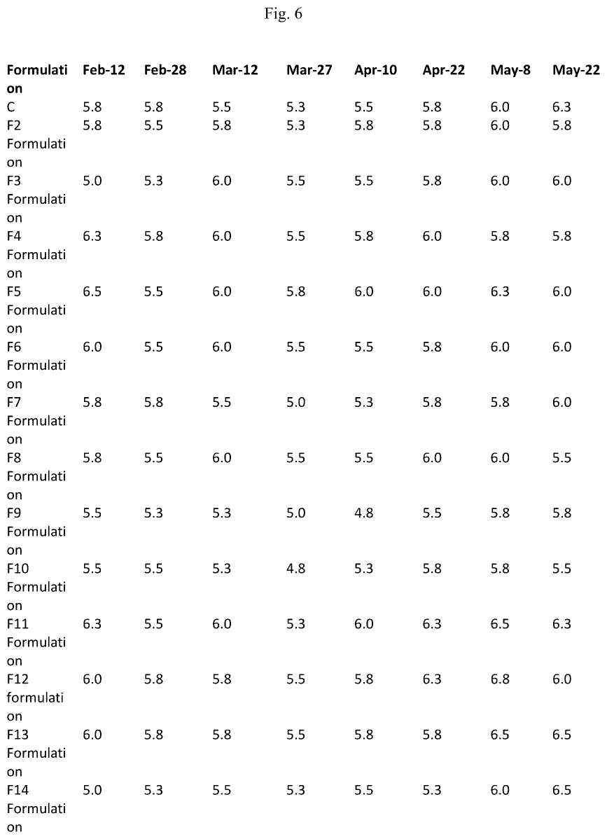

Wetting agent treatments influenced turfgrass quality, color, soil volumetric water content at 1.5 and 3 in, and soil moisture uniformity at 1.5 in. when averaged across rating dates (see FIG. 5). Plots applied with F5, F11, F12 and F13 formulations had a higher quality compared to those applied with F9 and F10 formulations. However, no difference was observed between wetting agent treatments and untreated control (see FIG. 5). A similar trend was observed for turfgrass color where F5 formulation had a better color than F9 and F10 formulations. Plots applied with F5, F8, F11 and F12 formulations had a higher soil volumetric water content than F9 and F14 formulations at 1.5 inches, and F2 and F14 formulations at 3 inches (see FIG. 5). Soil moisture uniformity was lower in plots applied with F4, F8 and F11 formulations, compared with F14 formulation. No differences were observed among treatments within weeks on evaluated variables (see FIGS. 6-13).

FIG. 5 shows field trial results for the treatment effect of F2-F14 formulations on turfgrass parameters.

FIG. 6 shows field trial results for the treatment effect of F2-F14 formulations on average bi-weekly turfgrass quality.

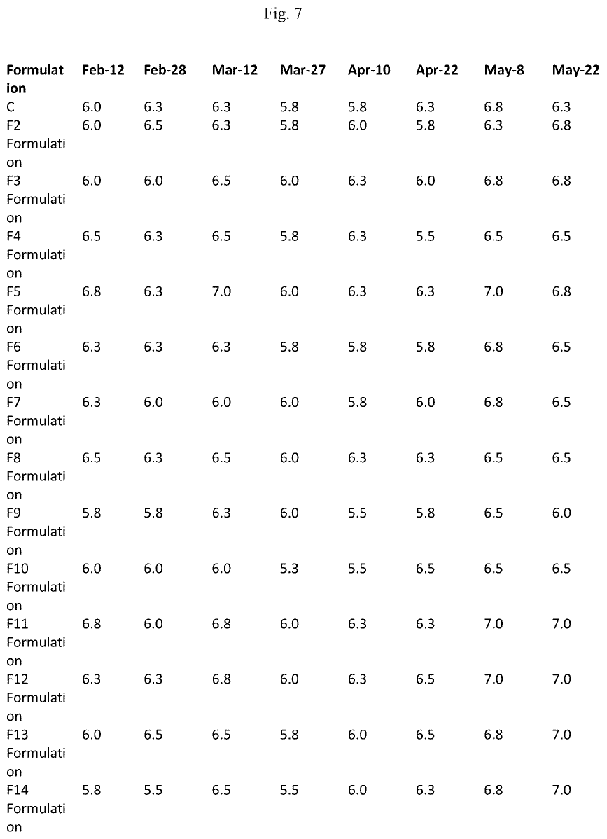

FIG. 7 shows field trial results for the treatment effect of F2-F14 formulations on average bi-weekly turfgrass color.

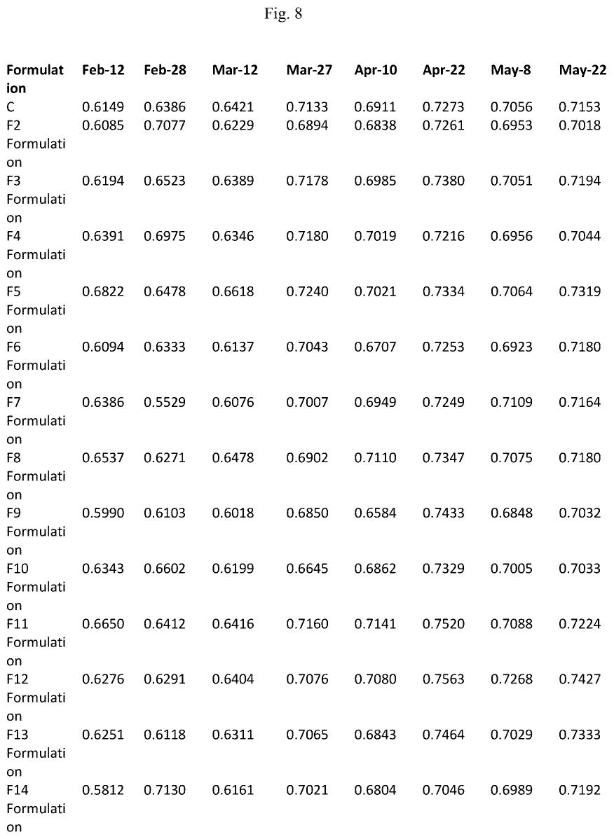

FIG. 8 shows field trial results for the treatment effect of F2-F14 formulations on average bi-weekly turfgrass NDVI.

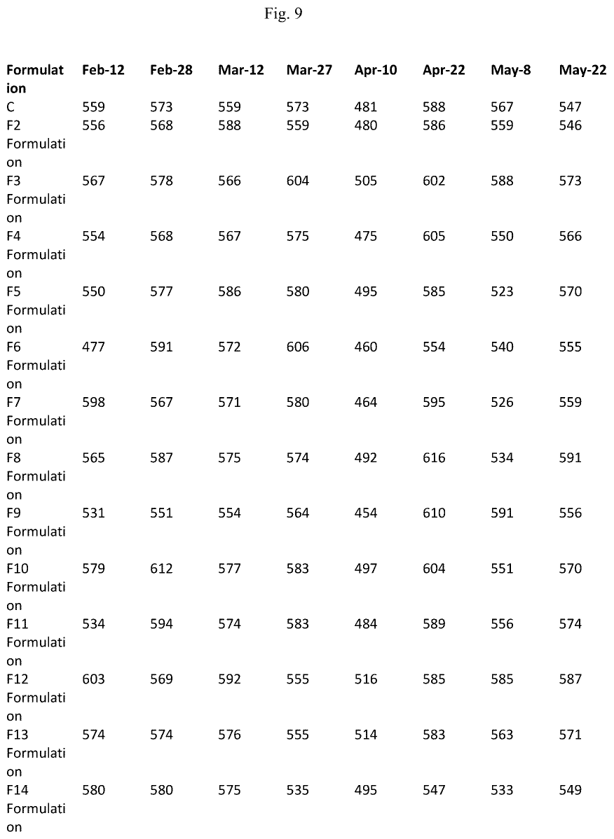

FIG. 9 shows field trial results for the treatment effect of F2-F14 formulations on average bi-weekly surface firmness.

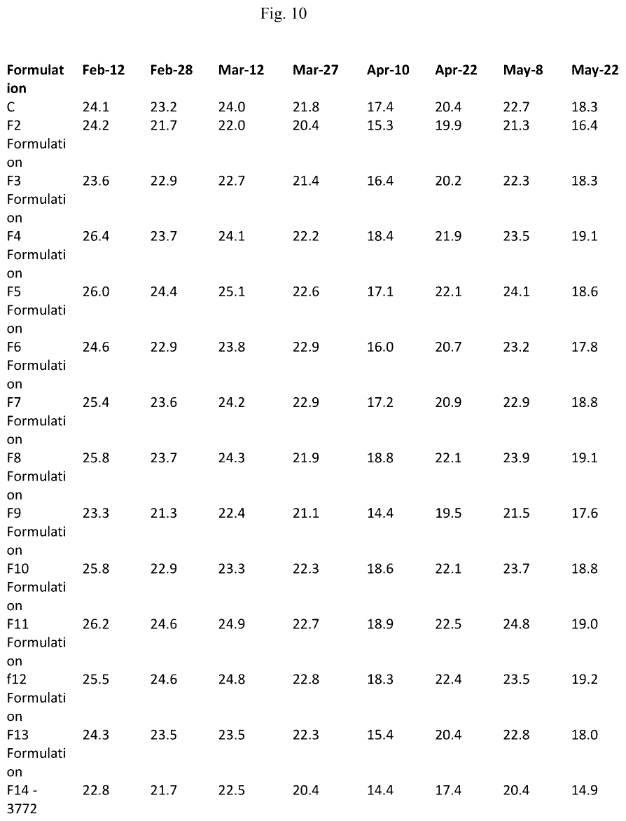

FIG. 10 shows field trial results for the treatment effect of F2-F14 formulations on average bi-weekly soil volumetric water content at 1.5 in.

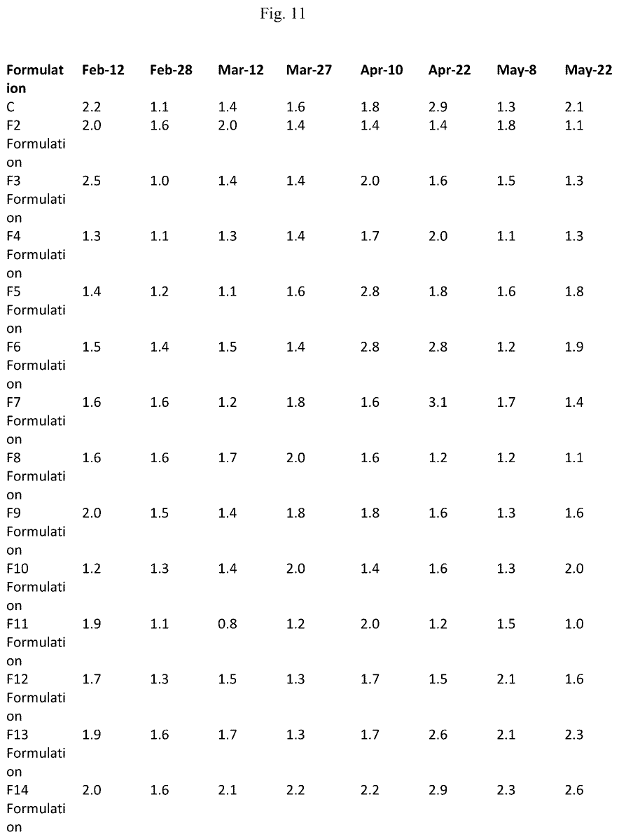

FIG. 11 shows field trial results for the treatment effect of F2-F14 formulations on average bi-weekly soil moisture uniformity at 1.5 in. A lower value means more uniform water distribution.

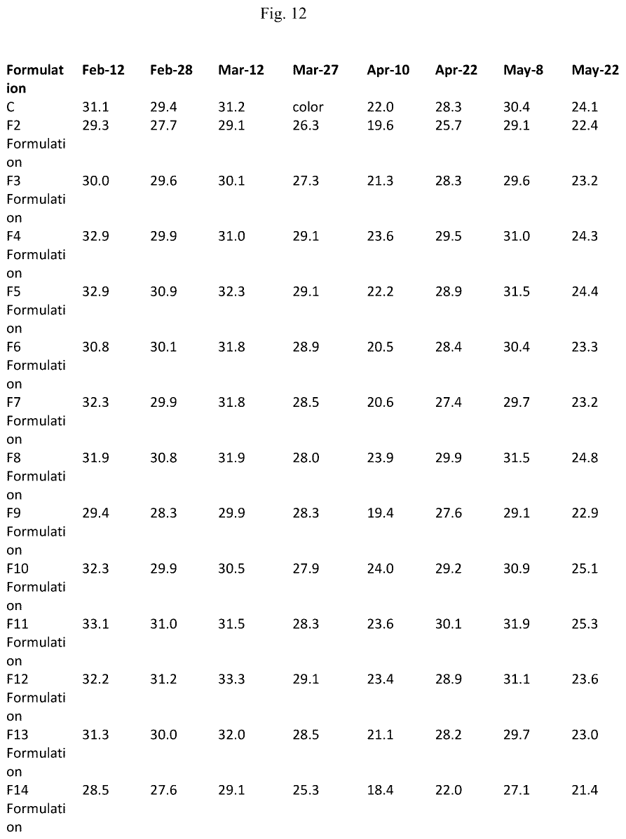

FIG. 12 shows field trial results for the treatment effect of F2-F14 formulations on average bi-weekly soil volumetric water content at 3 in.

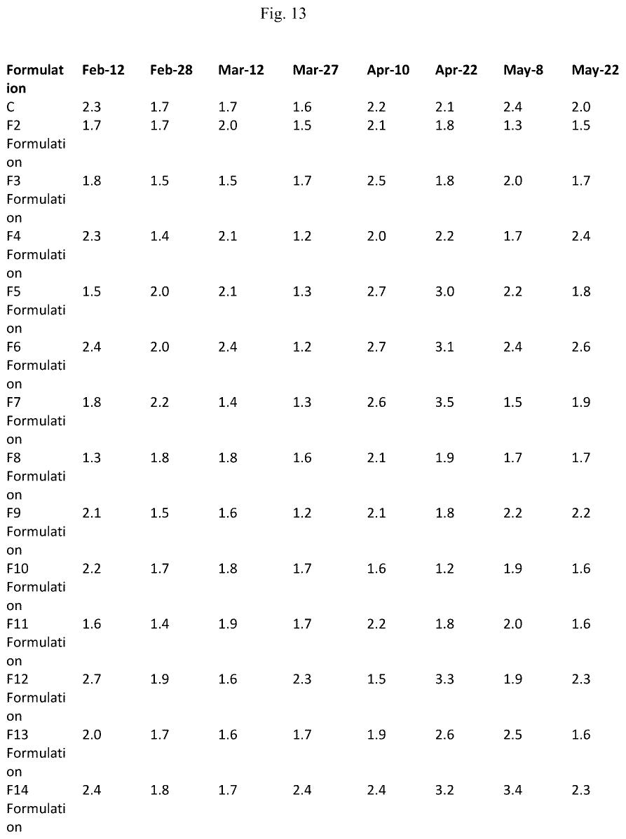

FIG. 13 shows field trial results for the treatment effect of F2-F14 formulations on average bi-weekly soil moisture uniformity at 3 in. A lower value means more uniform water distribution.

### Example 3

The procedures, materials, and methods described in the field trials in Example 2 were used to evaluate the performance of granular and/or naturally derived formulations of this disclosure compared to industry standard soil surfactants.

The product formulations were prepared using a variety of biosurfactants, namely, rhamnolipids and sophorolipids. The results also showcase their use as granular surfactants/wetting agents, by applying Astria liquid formula blends at 10% on naturally-derived granules. The two granular carriers evaluated were paper-based and compost-based.

### Liquid Blends:

Zipline—commercial synthetic product; 2 surfactant system with plant health benefit
Astria—naturally-derived product; 2 surfactant system with plant health benefit
   all versions of liquid Astria in this study contain sophorolipids in place of rhamnolipids
Astria BS1—formula prepared with sophorolipids in place of rhamnolipids
   GRANULAR blends:
Astria GI—rhamnolipid formula on paper granule
Astria G2—rhamnolipid formula on compost granule
Astria G3 & G4—sophorolipid formula on compost granule

All treatments were applied at 3 oz/M (liquid) or 2.51b/M (granular) every 14 days.

The original irrigation plan was to have 100% irrigation, followed by 50% irrigation (to simulate drought conditions), and again followed by 100% irrigation. This plan was modified due to unanticipated rainfall early in the study. As a result, the original irrigation was reduced to 80% (supplemented by rainfall), and reduced irrigation period of 50% had a delayed onset.

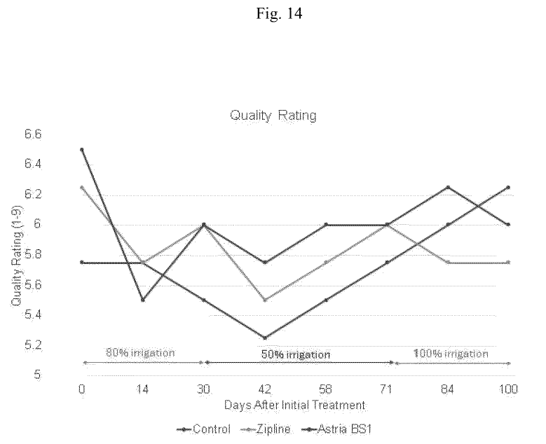

FIG. 14 graphically depicts quality rating for turf treated with liquid surfactants. Turf treated with liquid surfactants generally exhibited improved turf quality compared to control, which is particularly noticeable during the reduced irritation period.

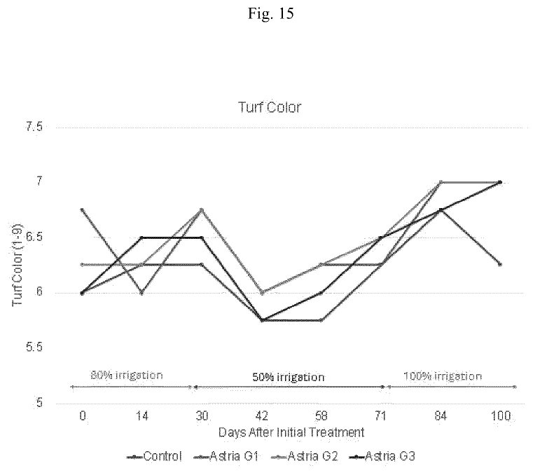

FIG. 15 graphically depicts turf color rating for turf treated with granular surfactants. Turf treated with granular surfactants generally exhibited improved turf quality during reduced irrigation period compared to control.

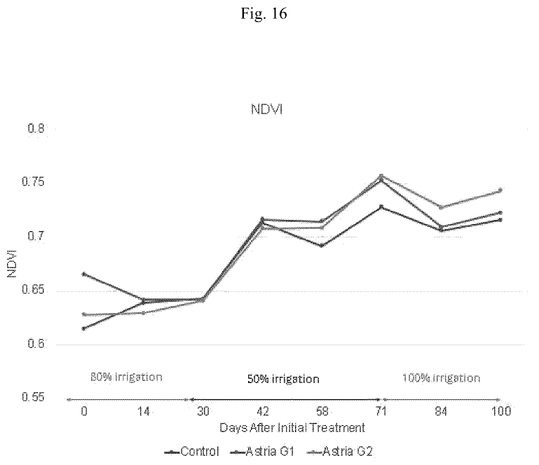

FIG. 16 graphically depicts normalized difference vegetation index (NDVI) for turf treated with granular surfactants. Turf treated with granular surfactants generally exhibited improved NDVI ratings in the second half of the reduced irrigation period compared to control.

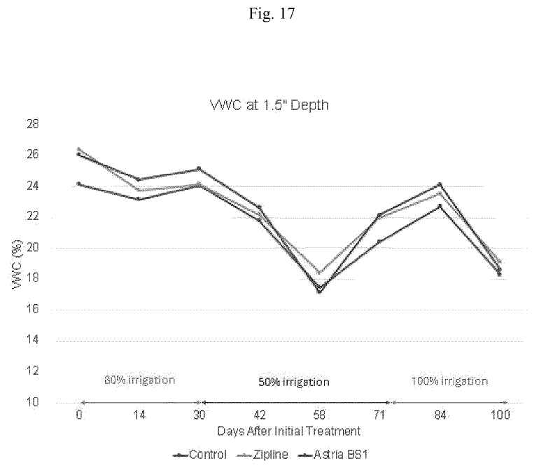

FIG. 17 graphically depicts volumetric water content (VWC) at 1.5″ depth for turf treated with liquid surfactants. Turf treated with liquid surfactants exhibited increased water content during the second half of the reduced irrigation period, exhibiting the biosurfactants ability to effectively retain moisture.

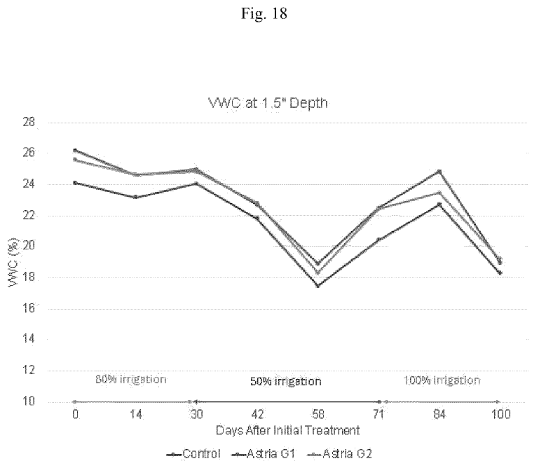

FIG. 18 graphically depicts volumetric water content (VWC) at 1.5″ depth for turf treated with granular surfactants. Turf treated with granular surfactants exhibited increased water content during the second half of the reduced irrigation period, exhibiting the biosurfactants ability to effectively retain moisture.

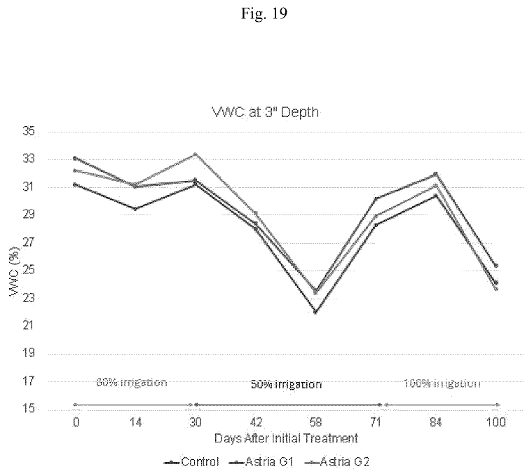

FIG. 19 graphically depicts volumetric water content (VWC) at 3″ depth for turf treated with granular surfactants. Turf treated with granular surfactants exhibited increased water content during the second half of the reduced irrigation period, exhibiting the biosurfactants ability to effectively retain moisture.

The present disclosure is not to be limited in scope by the specific embodiments described herein. Indeed, various modifications of the disclosure in addition to those described herein will become apparent to those skilled in the art from the foregoing description. Such modifications are intended to fall within the scope of the appended claims.

What is claimed is:

1. A turf grass treatment composition comprising at least one biosurfactant; wherein the turf grass treatment composition, when applied to turf grass, or to roots of the turf grass, or to soil in which the turf grass grows, is effective for enhancing quality of the turf grass.

2. The turf grass treatment composition of claim 1 wherein the least one biosurfactant is a growth byproduct of a microorganism.

3. The turf grass treatment composition of claim 2 wherein the microorganism is a genetically-modified (GM) microorganism or a non-genetically (non-GM) modified microorganism.

4. The turf grass treatment composition of claim 2 wherein the microorganism is selected from the group consisting of bacteria, yeast, and fungi.

5. The turf grass treatment composition of claim 1 wherein the least one biosurfactant is selected from the group consisting of glycolipids, lipopeptides, phospholipids, fatty acids, and polymeric surfactants.

6. The turf grass treatment composition of claim 1 wherein the biosurfactant is a glycolipid.

7. The turf grass treatment composition of claim 1 wherein the biosurfactant is a glycolipid selected from the group consisting of rhamnolipid, sophorolipid, mannosylerythritol lipid, and trehalose lipid.

8. The turf grass treatment composition of claim 1 wherein the biosurfactant is rhamnolipid or sophorolipid.

9. The turf grass treatment composition of claim 1 wherein the biosurfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 50 wt %, or from about 0.5 wt % to about 25 wt %, or from about 0.5 wt % to about 20 wt %, or from about 0.5 wt % to about 15 wt %, or from about 0.5 wt % to about 10 wt %, based on the total weight of the turf grass treatment composition.

10. The turf grass treatment composition of claim 1 further comprising at least one naturally-derived surfactant.

11. The turf grass treatment composition of claim 10 wherein the at least one naturally-derived surfactant is selected from the group consisting of fatty acid derivatives, saponins, natural extracts, plant derived oils, and lauric acid derivatives.

12. The turf grass treatment composition of claim 10 wherein the at least one naturally-derived surfactant is selected from the group consisting of alkyl polyglucoside, Yucca extract, palm oil, coconut oil, sodium lauryl sulfate, and sodium coco sulfate.

13. The turf grass treatment composition of claim 10 wherein the at least one naturally-derived surfactant is alkyl polyglucoside.

14. The turf grass treatment composition of claim 10 wherein the naturally-derived surfactant is produced from a naturally-derived source by mechanical and biological processes, and by a chemical reaction that alters a molecule of the naturally-derived source.

15. The turf grass treatment composition of claim 10 wherein the naturally-derived surfactant is present in an amount from about 0.01 wt % to about 99 wt %, or from about 0.1 wt % to about 95 wt %, or from about 0.5 wt % to about 90 wt %, or from about 0.5 wt % to about 80 wt %, or from about 0.5 wt % to about 75 wt %, or from about 0.5 wt % to about 70 wt %, or from about 0.5 wt % to about 65 wt %, or from about 0.5 wt % to about 60 wt %, or from about 0.5 wt % to about 55 wt %, or from about 0.5 wt % to about 50 wt %, based on the total weight of the turf grass treatment composition.

16. The turf grass treatment composition of claim 10 wherein the weight ratio of the biosurfactant to the naturally-derived surfactant is about 1:10, or about 1:9, or about 1:8, or about 1:7, or about 1:6, or about 1:5, or about 1:4, or about 1:3, or about 1:2, or about 1:1, or about 2:1, or about 3:1, or about 4:1, or about 5:1, or about 6:1, or about 7:1, or about 8:1, or about 9:1, or about 10:1.

17. The turf grass treatment composition of claim 1 further comprising at least one plant health component or biostimulant.

18. The turf grass treatment composition of claim 17 wherein the at least one plant health component or biostimulant is selected from the group consisting of plant hormones, microbes selected from bacteria, yeast, and fungi; humic substances, seaweed extracts, protein hydrolysates, chitosan, inorganic compounds, and metabolites.

19. The turf grass treatment composition of claim 1 further comprising at least one inert component.

20. The turf grass treatment composition of claim 19 wherein the at least one inert component comprises water.

21. The turf grass treatment composition of claim 1 which, when applied to turf grass, or to roots of the turf grass, or to soil in which the turf grass grows, enhances quality of the turf grass by:
enhancing initial water uptake or wetting, rewetting and/or water retention over time of said turf grass; or
enhancing surface tension reduction, increasing speed to wet, increasing water retention, and/or increasing time to dry between watering events; or
enhancing root structure and growth, nutrient use efficiency, water use efficiency, stress tolerance, disease tolerance, and/or inducing systemic resistance; or
enhancing strength of the turf grass roots by increasing root density, increasing root diameter, and/or increasing root depth; or
increasing or enhancing photosynthesis; photochemical activity; root enzyme activity; root mass; stress tolerance due to the production of superoxide dismutase enzymes; cytokinin activity under drying conditions to stimulate cell division; leaf moisture; α-tocopherol (vitamin E) and ascorbic acid (vitamin C) antioxidants found in chloroplasts; chlorophyll content; root length; shoot growth; phosphorus uptake; salt tolerance; leaf tissue nitrogen (N), phosphorus (P), potassium (K) and iron (Fe); soil moisture; and/or microbiome; or
making the nutrients far more recognizable to the turf grass; limiting temperature stress, drought stress, heavy metal stress, and low mowing heights; amino acid proline scavenges hydroxyl radicals by increasing superoxide dismutase (SOD); protein biosynthesis improvement; increasing chlorophyll content; increasing germination; stimulating carbon and nitrogen metabolism; and/or stimulating turf grass microbiomes; or
increasing or enhancing leaf count, amino acid proline scavenges hydroxyl radicals by increasing superoxide dismutase (SOD); proline dehydrogenase production/stress adaption; chlorophyll content; germination; and/or vertical leaf growth; or
strengthening cell walls by silica deposits; promoting turf grass growth; inducing tolerance to abiotic stress (drought, salinity, cold stress); inducing cell wall rigidification, osmoregulation, reducing transpiration; influencing osmotic, pH, and redox homeostasis; and/or influencing hormone signaling and enzymes involved in stress response; or
providing defense against abiotic stress; leaf and stem strength through deposition in the cuticle; maintaining cell wall polysaccharide and lignin polymersproline; wear resistance; heat and drought stressed resistance; growth and establishment; water use efficiency; salt stress tolerance; leaf blade stiffness; and/or better ball roll; or
increasing or enhancing uptake of macro- and micronutrients; root mass and surface area; cytokinin content; drought stress tolerance; arbuscule-forming mycorrhiza fungal may reduce Poa annua on golf greens; chlorophyll content; absorption of mineral elements such as phosphorus (P), iron (Fe), copper (Cu), magnesium (Mg), potassium (K), boron (B), silicon (Si), sulfur (S), and nitrogen (N); above ground biomass; water use efficiency; less irrigation in summer; and/or less artificial fertilizer for the same results; or
enhancing health, growth and/or sturdiness of the turf grass; or
enhancing turf grass color, turf grass shoot density, and/or turf grass greenness.

22. The turf grass treatment composition of claim 1 wherein the turf grass is selected from the group consisting of: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); Zoysia grass (Zoysia spp.); Bahia grass (Paspalum notatum); carpet grass (Axonopus affinis); centipede grass (Eremochloa ophiuroides); kikuyu grass (Pennisetum clandesinum); seashore Paspalum (Paspalum vaginatum); floratam (Stenotaphrum secundatum “Floratam”); blue gramma (Bouteloua gracilis); buffalo grass (Buchloe dactyloids); and/or sideoats gramma (Bouteloua curtipendula).

23. The turf grass treatment composition of claim 1 which is a microbe-based composition.

24. The turf grass treatment composition of claim 1 which is applied to the turf grass, or to roots of the turf grass, or to soil in which the turf grass grows, at a treatment rate from about 0.5 oz./1000 sq. ft. monthly to about 12 oz./1000 sq. ft. monthly, or from about 1.0 oz./1000 sq. ft. monthly to about 10 oz./1000 sq. ft. monthly, or from about 2.0 oz./1000 sq. ft. monthly to about 8 oz./1000 sq. ft. monthly.

25. A method of enhancing quality of turf grass, said method comprising: applying to the turf grass, or to roots of the turf grass, or to soil in which the turf grass grows, a composition comprising at least one biosurfactant; wherein the composition, when applied to turf grass, or to roots of the turf grass, or to soil in which the turf grass grows, is effective for enhancing quality of the turf grass.
